(19) United States
(12) Patent Application Publication
(10) Pub. No.: US 2026/0238040 A1
(43) Pub. Date: Aug. 13, 2026

(54) Autonomous High-Power Wireless Power Transfer System

(71) Applicant: Electrovia Technologies Corp., Nashville, TN (US)

(72) Inventors: Ronald Rumrill, Spring Hill, TN (US); Thomas Rush, Nashville, TN (US)

(73) Assignee: Electrovia Technologies Corp., Nashville, TN (US)

(21) Appl. No.: 19/534,532

(22) Filed: Feb. 9, 2026

Related U.S. Application Data
(60) Provisional application No. 63/756,237, filed on Feb. 9, 2025.

(51) Int. Cl. H02J 50/10; H02J 50/12; H02J 50/90

(52) U.S. Cl. CPC H02J 50/10; H02J 50/12; H02J 50/90

(57) ABSTRACT

A precast roadway inductive charging panel for dynamic wireless power transfer to a vehicle comprises a transmitter coil comprising a plurality of tubular conductors, each defining an interior channel configured to receive a cooling fluid therethrough. The panel further comprises one or more bus bar assemblies electrically coupled to the tubular conductors, each bus bar assembly comprising a planar conductive plate positioned at an end of at least two tubular conductors to form an electrical path through the transmitter coil. The panel also comprises a power electronics assembly electrically coupled to the transmitter coil and configured to provide high-frequency alternating current to the transmitter coil. The panel additionally comprises a ferromagnetic element comprising one or more protruded portions arranged between at least two adjacent tubular conductors.

### CROSS-REFERENCE TO RELATED APPLICATIONS

This application claims priority to U.S. Application No. 63/756,237, titled Autonomous High-Power Wireless Power Transfer System, filed Feb. 9, 2025, which is hereby incorporated by reference in its entirety.

### FIELD OF INVENTION

The present disclosure relates to wireless power transfer systems for electric vehicles, and more particularly to a dynamic wireless power transfer system utilizing precast concrete roadway panels with embedded transmitter coils, integrated power electronics, and thermal management for high-power inductive charging of heavy-duty trucks during transit.

### BACKGROUND

Electric vehicles within the scope of the present disclosure may for example include heavy-duty trucks, commercial transport vehicles, buses, delivery vehicles, rail systems, and other ground-based transportation platforms, to name but a few examples. The present disclosure may also be applicable to transportation platforms that may utilize various charging nodes, including electric vertical takeoff and landing (eVTOL) aircraft.

These electric vehicles may typically have wheeled ground-engaging units, an electric propulsion system including one or more electric motors, and an onboard energy storage system such as a battery pack. Electric vehicles as disclosed herein may include for example one or more receiver assemblies, which includes one or more electromagnetic components, that is configured to receive wireless power transfer from external infrastructure to supplement or replenish the onboard energy storage during vehicle operation.

Wireless power transfer systems for electric vehicles may generally be categorized into static charging systems and dynamic charging systems. Static wireless charging systems may provide power transfer when a vehicle is stationary and positioned over a charging pad, such as in a parking location or at a designated charging station. Dynamic wireless power transfer systems, in contrast, may provide power transfer while a vehicle is in motion along a roadway equipped with embedded transmitter infrastructure. Dynamic systems may enable vehicles to receive charging during transit, potentially extending operational range without requiring dedicated charging stops. Semi-static wireless charging systems may provide power transfer when a vehicle is temporarily stationary or moving at low speed, such as during brief stops, queuing, or controlled movement, enabling energy transfer without requiring full parking-duration dwell times.

Conventional dynamic wireless power transfer systems may utilize inductive coupling between transmitter coils embedded in or beneath a roadway surface and receiver coils mounted on the underside of vehicles. These systems may typically operate at high frequencies to achieve efficient electromagnetic coupling across an air gap between the roadway and the vehicle. The transmitter infrastructure may include coils constructed from conductive materials such as litz wire, along with ferromagnetic materials to concentrate magnetic flux, and power electronics to generate the alternating current supplied to the transmitter coils.

One of the conventional challenges with dynamic wireless power transfer systems relates to thermal management during high-power operation. When transferring power at levels sufficient for heavy-duty vehicle applications, the transmitter coils and associated electronics may generate substantial heat. Conventional systems may address thermal concerns by limiting power transfer rates, reducing duty cycles, or positioning power electronics remotely from the transmitter coils. However, these approaches may constrain system performance or increase infrastructure complexity. Additionally, conventional coil constructions using solid conductors or litz wire may have limited capacity for integrated cooling solutions due to the inability to effectively remove heat from the solid conductors.

Another conventional challenge involves the spatial coverage provided by transmitter panels arranged along a roadway. When transmitter coils are configured with rectangular geometries, transitions between adjacent panels may create regions of reduced magnetic field strength where power transfer efficiency decreases. In particular, traditional implementations employing litz wire or other stranded conductors impose minimum turning-radius constraints that limit how closely active coil windings can extend to panel edges, thereby reducing the effective charging area and increasing dead-zones between adjacent panels. These transition regions may accumulate over long stretches of charged roadway, potentially reducing the overall charging effect experienced by vehicles traversing the infrastructure. Conventional systems designed for static charging applications, where vehicles remain positioned over a single pad, may not have addressed these transition effects to the same degree as may be desired for continuous dynamic charging over extended distances.

Conventional dynamic wireless power transfer implementations may also face challenges related to electromagnetic interference between adjacent transmitter panels. When multiple panels operate in close proximity, their electromagnetic fields may interact in ways that reduce power transfer efficiency or create undesirable field patterns. Conventional approaches may address this by spacing panels apart, which may reduce the effective charging coverage along the roadway. Coordinating the operation of numerous panels across an extended charging section may present additional complexity in terms of timing, phase relationships, and power distribution management.

The integration of transmitter infrastructure into roadway surfaces presents further conventional challenges. Embedding coils and electronics within pavement structures may require consideration of structural integrity, serviceability, and dimensional constraints imposed by roadway construction standards. Conventional systems may separate power electronics from the embedded coil assemblies, which may increase installation complexity and reduce modularity. The ability to replace or service individual components within an embedded roadway installation may be limited by how the various system elements are integrated and encapsulated.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The current disclosure provides an enhancement to conventional dynamic wireless power transfer systems, at least in part by integrating transmitter coils constructed from tubular conductors with interior cooling channels, elevated ferromagnetic elements, and active power electronics within each singular modular precast concrete roadway panels. These features may enable efficient high-power wireless charging of heavy-duty vehicles during transit without requiring dedicated charging stops. These features may further enable extended operational range for electric vehicles by providing continuous power transfer across long stretches of charged roadway infrastructure.

In one particular and exemplary embodiment, a precast roadway inductive charging panel is disclosed herein for dynamic wireless power transfer to a vehicle. The panel comprises a transmitter coil comprising a plurality of tubular conductors, each one of the plurality of tubular conductors defining an interior channel configured to receive a cooling fluid therethrough. The panel further comprises one or more bus bar assemblies electrically coupled to the plurality of tubular conductors, each bus bar assembly comprising a planar conductive plate positioned at an end of at least two tubular conductors of the plurality of tubular conductors to form an electrical path through the transmitter coil. The panel also comprises a power electronics assembly electrically coupled to the transmitter coil and configured to provide high-frequency alternating current to the transmitter coil. The panel additionally comprises a ferromagnetic element comprising one or more protruded portions arranged between at least two adjacent ones of the plurality of tubular conductors.

In one exemplary aspect according to the above-referenced panel embodiment, the plurality of tubular conductors may comprise a first plurality of tubular conductors and a second plurality of tubular conductors, wherein the one or more protruded portions of the ferromagnetic element are arranged between the first plurality of tubular conductors and the second plurality of tubular conductors, and wherein adjacent ones of the first plurality of tubular conductors and of the second plurality of tubular conductors do not include the one or more protruded portions there between.

In another exemplary aspect according to the above-referenced panel embodiment and optional aspects thereof, a first bus bar assembly of the at least two bus bar assemblies may be arranged at a first end of both the first plurality and second plurality of tubular conductors, wherein the planar conductive plate comprises a plurality of conductive plates forming a staggered interconnect arrangement, each conductive plate electrically coupling a different overlapping subset of conductors of the first plurality of tubular conductors with a different overlapping subset of the second plurality of conductors.

In another exemplary aspect according to the above-referenced panel embodiment and optional aspects thereof, the panel may further comprise, for each of the plurality of tubular conductors, a cooling fluid connection between a single one of the first plurality of tubular conductors and a single one of the second plurality of tubular conductors.

In another exemplary aspect according to the above-referenced panel embodiment and optional aspects thereof, the one or more protruded portions may elevate the ferromagnetic element above a plane defined by bottom surfaces of the plurality of tubular conductors.

In another exemplary aspect according to the above-referenced panel embodiment and optional aspects thereof, the one or more protruded portions may elevate the ferromagnetic element above a plane defined by top surfaces of the plurality of tubular conductors.

In another exemplary aspect according to the above-referenced panel embodiment and optional aspects thereof, the plurality of tubular conductors may comprise copper.

In another exemplary aspect according to the above-referenced panel embodiment and optional aspects thereof, the panel may further comprise a concrete body encasing the transmitter coil, the at least two bus bar assemblies, the power electronics assembly, and the ferromagnetic element.

In another exemplary aspect according to the above-referenced panel embodiment and optional aspects thereof, the panel may further comprise at least one support plate or frame extending across at least a portion of the transmitter coil, a tensile and compressive reinforcement bar, and wherein the at least one support plate comprises a first indentation configured to contact each of the plurality of tubular conductors across which the at least one support plate extends and a second indentation configured to contact the reinforcement bar.

In another exemplary aspect according to the above-referenced panel embodiment and optional aspects thereof, the at least two adjacent ones of the plurality of tubular conductors astride the one or more protruded portions may comprise a diameter smaller than the others of the plurality of tubular conductors.

In another exemplary aspect according to the above-referenced panel embodiment and optional aspects thereof, the panel may further comprise a non-rectangular trapezoidal planform.

In another exemplary aspect according to the above-referenced panel embodiment and optional aspects thereof, the panel may further comprise an oblique parallelogram planform.

In another exemplary aspect according to the above-referenced panel embodiment and optional aspects thereof, the power electronics assembly may be disposed within a magnetic field generated by the transmitter coil, and the panel may further comprise a shielding layer disposed between the transmitter coil and the power electronics assembly.

In another exemplary aspect according to the above-referenced panel embodiment and optional aspects thereof, the shielding layer may comprise aluminum.

In another embodiment as disclosed herein, a dynamic wireless power transfer system comprises a plurality of precast roadway inductive charging panels arranged in an end-to-end configuration to form a continuous driving surface sitting flush with the pavement or could be embedded underneath or within the driving surface. Each panel of the plurality of panels comprises a transmitter coil comprising a plurality of tubular conductors, each of the plurality of tubular conductors defining an interior channel configured to receive a cooling fluid therethrough. Each panel further comprises at least two bus bar assemblies electrically coupled to the plurality of tubular conductors creating the transmitting coil, each bus bar assembly comprising a planar conductive plate positioned at a respective end of at least two of the plurality of tubular conductors to form a continuous electrical path through the transmitter coil. Each panel also comprises a power electronics assembly electrically coupled to the transmitter coil and configured to provide high-frequency alternating current to the transmitter coil. Each panel additionally comprises a ferromagnetic element comprising one or more protruded portions arranged between at least two adjacent ones of the plurality of tubular conductors. Each panel also comprises at least two additional bus bars from end-to-end of the primary transmitting panel designed to create an interconnected shared electrical bus amongst the plurality of panels which could be installed in any implementation. Each panel also comprises cooling pipes designed to distribute cooling fluid to the respective panel, and also onwards to the next panel in the plurality of panels. The system further comprises one or more vehicle-mounted receiver assemblies configured to be positioned beneath a vehicle and to inductively receive power from the plurality of precast roadway inductive charging panels, the receiver assembly comprising a receiver coil selectively electromagnetically coupleable to the transmitter coil of at least one of the plurality of panels. The system also comprises a power supply infrastructure electrically coupled to the plurality of panels and configured to convert power from a power grid into DC power distributed to each of the plurality of panels. The system additionally comprises a command and control system communicatively coupled to the plurality of panels and configured to regulate power distribution to the plurality of panels.

In one exemplary aspect according to the above-referenced system embodiment, a plurality of intermediate ones of the plurality of panels may comprise a non-rectangular trapezoidal planform.

In another exemplary aspect according to the above-referenced system embodiment and optional aspects thereof, the plurality of panels may comprise a plurality of separated panel segments, each panel segment separated by a road segment devoid of any panel.

In another exemplary aspect according to the above-referenced system embodiment and optional aspects thereof, at least one of the plurality of separated panel segments may extend over half a mile.

In another exemplary aspect according to the above-referenced system embodiment and optional aspects thereof, the command and control system may be configured to synchronize phase angles of the high-frequency alternating current across the plurality of panels such that adjacent panels operate at nearly identical phase angles with a fixed offset there between.

In another exemplary aspect according to the above-referenced system embodiment and optional aspects thereof, the receiver coil may comprise a plurality of receiver tubular conductors, each receiver tubular conductor defining an interior channel configured to receive a cooling fluid from a cooling system of the vehicle, and the receiver assembly may further comprise a ferromagnetic material disposed between at least two adjacent ones of the plurality of receiver tubular conductors.

Numerous objects, features, and advantages of the embodiments set forth herein will be readily apparent to those skilled in the art upon reading of the following disclosure when taken in conjunction with the accompanying drawings.

The foregoing general description of the illustrative embodiments and the following detailed description thereof are merely exemplary aspects of the teachings of this disclosure and are not restrictive.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a schematic diagram representing an exemplary dynamic wireless power transfer system according to an embodiment of the present disclosure.

FIG. 2 is a schematic diagram representing an exemplary road system utilizing the dynamic wireless power transfer system of FIG. 1 according to an embodiment of the present disclosure.

FIG. 3A is a top plan view of a plurality of roadway panels arranged in an end-to-end configuration with a non-rectangular trapezoidal planform according to an embodiment of the present disclosure.

FIG. 3B is a top plan view of a plurality of roadway panels arranged in an end-to-end configuration with an oblique parallelogram planform according to an embodiment of the present disclosure.

FIG. 4 is a top perspective view of a transmitter panel assembly according to an embodiment of the present disclosure.

FIG. 5 is a bottom perspective view of the transmitter panel assembly of FIG. 4 according to an embodiment of the present disclosure.

FIG. 6 is a top plan view of the transmitter panel assembly of FIG. 4 according to an embodiment of the present disclosure.

FIG. 7 is a magnified perspective view of a longitudinal end of the transmitter panel assembly of FIG. 4 according to an embodiment of the present disclosure.

FIG. 8 is a top plan view of a magnified end portion of the transmitter panel assembly of FIG. 4 according to an embodiment of the present disclosure.

FIG. 9A is an isometric perspective view of a longitudinal end of the transmitter panel assembly of FIG. 4 showing cooling fluid connections according to an embodiment of the present disclosure.

FIG. 9B is an isometric perspective view of a different longitudinal end of the transmitter panel assembly of FIG. 4 showing manifold cooling connections according to an embodiment of the present disclosure.

FIG. 10 is a side sectional view of the transmitter panel assembly of FIG. 4 according to an embodiment of the present disclosure.

FIG. 11 is an isometric perspective view of a receiver panel assembly according to an embodiment of the present disclosure.

FIG. 12 is a bottom perspective view of the receiver panel assembly of FIG. 11 with a bottom panel removed according to an embodiment of the present disclosure.

FIG. 13A is a bottom plan view of the receiver panel assembly of FIG. 11 according to an embodiment of the present disclosure.

FIG. 13B is a magnified bottom plan view of the receiver panel assembly of FIG. 11 showing receiver resonant power circuitry according to an embodiment of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

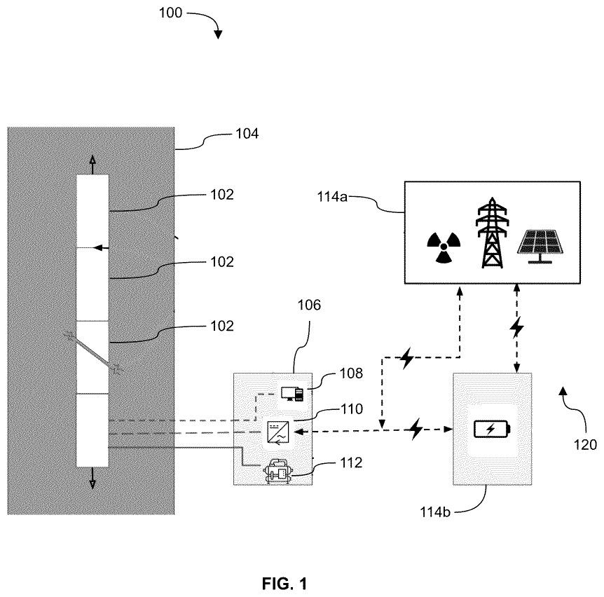

FIG. 1 illustrates a schematic diagram of a dynamic wireless power transfer system 100. The system 100 is configured for deployment in long continuous sequences of hundreds of panels over approximately one mile to provide continuous end-to-end coverage for vehicles traveling along a roadway. In the embodiment represented in FIG. 1, the system 100 includes a plurality of precast roadway inductive charging panels, referred to herein as roadway panels 102, arranged in an end-to-end configuration within a roadway pavement 104. The roadway panels 102 form a continuous driving surface over which vehicles may travel while receiving wireless power transfer. The transitions between adjacent roadway panels 102 in the end-to-end configuration are devoid of existing roadway surface, with the roadway panels 102 themselves forming the driving surface rather than being embedded beneath or within a separate pavement layer. The roadway pavement 104 is indicated by a background in FIG. 1, with the roadway panels 102 positioned in an end-to-end configuration.

The system 100 is configured to support multiple operational modes including dynamic charging, semi-static charging, and static charging. In-motion wireless charging, also referred to as dynamic wireless power transfer, provides power to vehicles while traveling at highway speeds or other sustained velocities. Semi-static wireless charging provides power transfer when a vehicle is temporarily stationary or moving at reduced speeds, such as during queuing at traffic signals, loading and unloading operations, or controlled low-speed movement through designated zones. Static wireless charging provides power transfer when a vehicle remains stationary over the transmitter infrastructure for extended periods. The same transmitter infrastructure of the system 100 supports multiple operational modes, with the charging mode determined by vehicle speed, dwell time, or operational parameters configured through the command and control system rather than requiring distinct hardware configurations.

With continued reference to FIG. 1, the system 100 includes an off-board supply 106 that is electrically and fluidly connected to the roadway panels 102. The off-board supply 106 contains a controller 108 that forms part of a command and control system communicatively coupled to the plurality of roadway panels 102 and configured to monitor and regulate power distribution to the roadway panel 102. The off-board supply 106 also includes a power rectifier or inverter 110 for supplying voltage for charging panel operation, and a cooling system 112 for thermal management of the roadway panels 102. The controller 108, the power rectifier 110, and the cooling system 112 of the off-board supply 106 are electrically and/or fluidly connected to the roadway panels 102 and to the power infrastructure 120 to provide power from the power infrastructure 120 to the roadway panels 102.

As further shown in FIG. 1, the system 100 includes grid power sources 114a, 114b, including grid power 114a or a grid power enabled battery 114b. The grid power sources 114a, 114b may include different types of grid power sources that may supply power to the system 100. The grid power 114a and/or the grid power enabled battery 114b, collectively power infrastructure 120, are electrically connected to each other and to the road panels through the off-board supply 106 through various transmission lines. The power infrastructure 120 forms part of a power supply infrastructure that is electrically coupled to the plurality of roadway panels 102 and configured to convert power from a power grid into DC power distributed to each of the roadway panels 102. The bidirectional connections provide power flow between these various power infrastructure 120 components and roadway panel 102, allowing for energy storage and distribution as vehicles traverse the roadway panels 102.

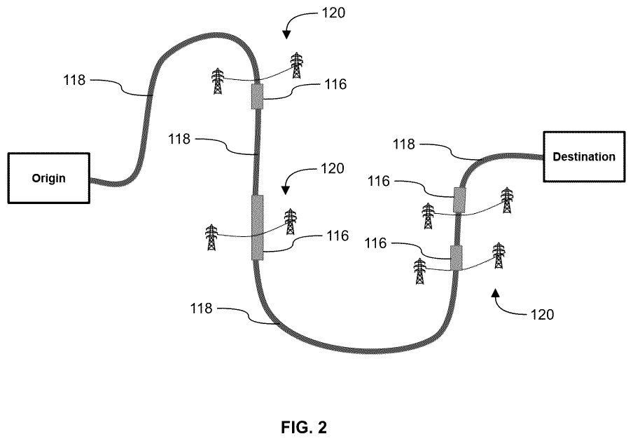

FIG. 2 illustrates a schematic diagram of a road system utilizing the dynamic wireless power transfer system 100, depicting an exemplary vehicle path from an origin to a destination. A continuous roadway extends from the origin to the destination, with the roadway comprising alternating sections of a charged pavement 116 and a non-charged pavement 118.

With continued reference to FIG. 2, the charged pavement 116 sections may be positioned at various points along the roadway path, representing precast roadway inductive charging panels arranged in end-to-end configurations. The non-charged pavement 118 sections may be arranged between the charged pavement 116 segments, representing standard roadway surfaces without embedded charging infrastructure. In the embodiment represented in FIG. 2, the plurality of roadway panels 102 comprise a plurality of separated panel segments, with each panel segment separated by a road segment devoid of any panel. The road segments devoid of any panel correspond to the non-charged pavement 118 sections positioned between adjacent charged pavement 116 sections along the vehicle path.

As further shown in FIG. 2, the power infrastructure 120 is depicted as electrical transmission tower icons positioned adjacent to each charged pavement 116 section. The power infrastructure 120 provides electrical connections to the charged pavement 116 sections, enabling power delivery from the grid to the roadway charging panels. Multiple instances of the power infrastructure 120 are distributed along the route, with each instance positioned near a corresponding charged pavement 116 section. The arrangement demonstrates how the charged pavement 116 sections of varying lengths may be strategically interspersed along a roadway to provide cumulative charging effects for vehicles traveling from origin to destination and to minimize the distance the power infrastructure needs to be installed to get to each respective charging section 116.

In various embodiments, at least one of the plurality of separated panel segments extends over half a mile. The lengths of the charged pavement 116 sections may vary to provide a desired amount of charging to vehicles traveling over the charged pavement 116 sections. For example, a charged pavement 116 section may consist of approximately 350-750 roadway panels 102 arranged end-to-end to cover distances over half a mile, providing inductive charging as a vehicle traverses the section. In some cases, the arrangement and characteristics of the charged pavement 116 sections may vary based on factors such as desired speed, established speed limits along the route, or periods of increased or decreased vehicle speeds determined through historical measurements, real-time tracking, or traffic-flow modeling. Areas where vehicles travel at lower speeds, such as residential or congested roadway segments, may utilize shorter charged pavement 116 sections, as vehicles spend more time over each panel. Conversely, open-highway segments, where vehicles travel more quickly, may utilize longer charged pavement 116 sections to provide a comparable charging effect. This configuration of separated panel segments interspersed with the non-charged pavement 118 sections creates a net charging effect along the journey from origin to destination, enabling vehicles to maintain energy levels without prolonged stops for charging.

The wireless power transfer system 100 is adapted for various transportation platforms beyond roadway vehicles. In various embodiments, the transmitter panel assemblies 200 are embedded within rail infrastructure to provide wireless charging for electric rail vehicles, light rail systems, or other rail-based transportation. The transmitter panel assemblies 200 are arranged along rail corridors in configurations that accommodate rail vehicle geometries and operational characteristics. In other embodiments, the transmitter panel assemblies 200 are installed at landing pads, taxiways, or other ground-based infrastructure for electric vertical takeoff and landing (eVTOL) aircraft, providing wireless charging during ground operations without requiring physical electrical connections. The receiver panel assemblies 300 are configured for mounting on various vehicle types including trucks, buses, delivery vehicles, rail cars, or aircraft, with the receiver geometry and mounting arrangement adapted to the particular vehicle platform. In some configurations, the same transmitter infrastructure serves multiple vehicle types operating in different modes, such as providing dynamic charging for vehicles in motion and static charging for vehicles that are temporarily stationary.

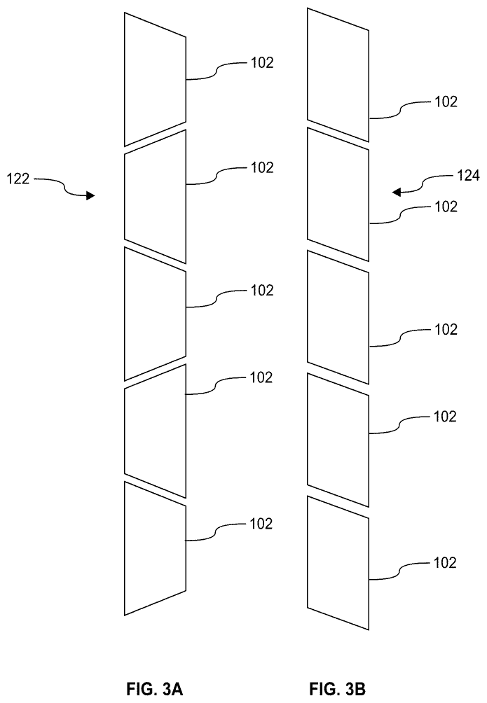

FIG. 3A illustrates a top plan view of a plurality of roadway panels 102 arranged in an end-to-end configuration, where each roadway panel 102 comprises a non-rectangular trapezoidal planform 122. The non-rectangular trapezoidal planform 122 may be characterized by an outer shape outline of the roadway panel 102 when viewed from a top plan view. The non-rectangular trapezoidal planform 122 includes four sides with at least two parallel sides and interior angles that are not right angles. In the embodiment represented in FIG. 3A, the roadway panels 102 are arranged in alternating orientations along the vertical direction, with adjacent panels having complementary shapes that allow close alignment between panels. This configuration creates overlapping regions between adjacent roadway panels 102 within a charged pavement 116 section. The end-to-end configuration positions the roadway panels 102 such that the transitions between adjacent panels are devoid of existing roadway surface material, with the panels arranged to sit flush with surrounding pavement or to form the driving surface directly.

With continued reference to FIG. 3A, the non-rectangular trapezoidal planform 122 of each roadway panel 102 is configured such that transmitter coil ends are shaped in a trapezoidal configuration so that coils extend partially into the neighboring panel's region. This arrangement prevents the magnetic field from terminating abruptly at the boundary between adjacent roadway panels 102. In conventional rectangular panel configurations, non-functional dead zones may occur between sequential panels where the magnetic flux density decreases as a receiver coil moves along the array. The non-rectangular trapezoidal planform 122 mitigates this limitation by aligning the last section of one coil with the first section of the next transmitter, thereby reducing dead zones and maintaining a more consistent power transfer as vehicles traverse the charged pavement 116 sections.

FIG. 3B illustrates a top plan view of a plurality of roadway panels 102 arranged in an end-to-end configuration, where each roadway panel 102 comprises an oblique parallelogram planform 124. The oblique parallelogram planform 124 includes four sides with two pairs of parallel sides and interior angles that are not right angles. Similar to the configuration shown in FIG. 3A, the roadway panels 102 in FIG. 3B are arranged vertically with consistent alignment between adjacent panels, providing continuous coverage along the roadway direction. The transitions between adjacent roadway panels 102 in the oblique parallelogram configuration are similarly devoid of existing roadway surface, enabling direct panel-to-panel contact or minimal separation without intervening pavement material.

As further shown in FIG. 3B, the oblique parallelogram planform 124 enables close proximity between adjacent roadway panels 102 to maximize the charging effect as vehicles traverse the charged pavement 116 section. The oblique parallelogram planform 124 provides an alternative panel geometry that similarly extends coil regions partially into neighboring panel regions, preventing abrupt termination of the magnetic field at panel boundaries. In various embodiments, a plurality of intermediate ones of the plurality of roadway panels 102 comprise the non-rectangular trapezoidal planform 122, while in other embodiments the roadway panels 102 may comprise the oblique parallelogram planform 124. Both planform configurations increase the relative charging time for vehicles traveling over the roadway panels 102 and help eliminate dead zones that may otherwise occur between panels in long continuous sequences of the system 100.

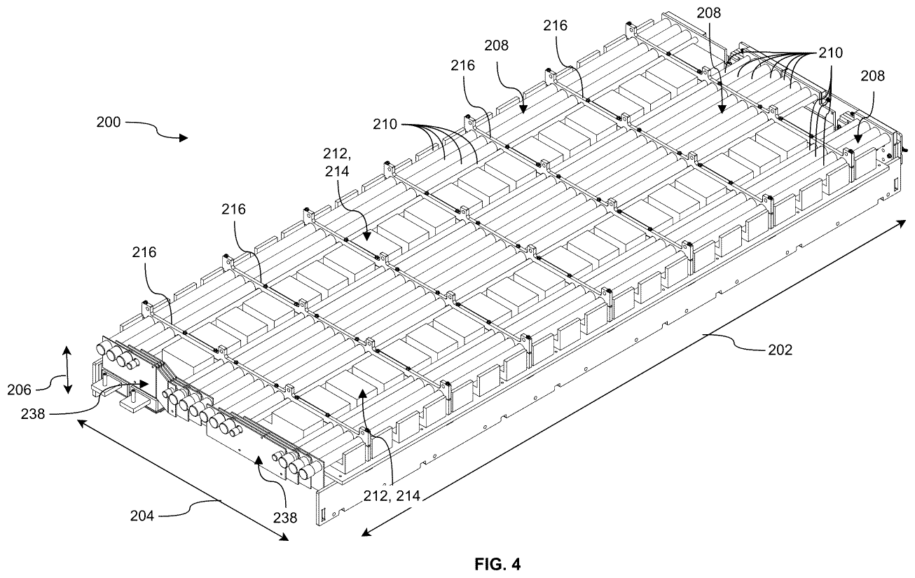

FIG. 4 illustrates a top perspective view of a transmitter panel assembly 200 for the dynamic wireless power transfer system 100, shown from an elevated angle that reveals the internal arrangement of components within the panel structure. The transmitter panel assembly 200 is configured for embedding within each of the roadway panels 102 to provide inductive charging capability as vehicles traverse the charged pavement 116 sections. In the embodiment represented in FIG. 4, the transmitter panel assembly 200 presents an elongated configuration with a transmitter panel length 202 extending along the longitudinal axis of the panel, a transmitter panel width 204 spanning the lateral dimension, and a transmitter panel height 206 defining the vertical extent of the assembly. In an exemplary aspect, the transmitter panel assembly 200 is approximately 7 feet long and 3 feet wide with a total thickness of approximately 9 to 10 inches when cast into concrete.

The dimensions of the transmitter panel assembly 200 may be tailored according to intended use cases or characteristics associated with vehicles equipped with corresponding receiver panel assemblies. In some aspects, the transmitter panel width 204 is selected to position the transmitter panel assembly 200 within the wheel track width of vehicles traversing the charged pavement 116 sections, such that tire loading from vehicle weight and travel is not experienced directly on the transmitter panel assembly 200. This configuration may reduce mechanical stress on the transmitter panel assembly 200 and extend service life by avoiding repeated direct tire contact during vehicle passage. In other aspects, the transmitter panel length 202 or the transmitter panel width 204 may be adjusted to accommodate different vehicle geometries, receiver coil dimensions, or roadway lane configurations.

With continued reference to FIG. 4, the transmitter panel assembly 200 includes a transmitter coil 208 positioned within the assembly. The transmitter coil 208 comprises a plurality of tubular conductors 210 arranged in multiple parallel rows extending along the transmitter panel length 202. Each tubular conductor of the plurality of tubular conductors 210 has a cylindrical profile suitable for carrying high-frequency alternating current and defines an interior channel configured to receive cooling fluid therethrough for thermal management during power transfer operations. The plurality of tubular conductors 210 comprise copper, and in the embodiment represented in FIG. 4, the transmitter coil 208 is made from copper pipe instead of traditional Litz wire. This particular configuration mitigates the high-frequency skin effect where only the outer surface of conductors is useful for carrying high-frequency alternating current, thereby eliminating wasted internal copper that would otherwise be present in solid conductors. The hollow copper pipe construction also allows water cooling through the interior channels of the plurality of tubular conductors 210, addressing higher heat loads associated with high-power transfer operations.

The plurality of tubular conductors 210 extend substantially an entire length of the transmitter panel assembly 200 to provide maximum efficiency and effective charging area during in-motion or dynamic inductive charging operations. By spanning nearly the full transmitter panel length 202, the plurality of tubular conductors 210 maximize the active charging region available as vehicles traverse each roadway panel 102. As will be described further herein, tight electrical coupling of various segments of the transmitter coil 208 is achieved throughout the transmitter panel assembly 200 through the bus bar assemblies 238 and the arrangement of the plurality of tubular conductors 210 relative to the ferromagnetic element 212. This configuration provides a desired ratio of the tubular conductors of the transmitter coil 208 relative to the ferromagnetic material, optimizing the magnetic flux characteristics for efficient power transfer across the air gap to a vehicle-mounted receiver assembly.

The arrangement of the plurality of tubular conductors within the transmitter panel assembly may be selected to promote a desired magnetic field distribution while limiting parasitic loss mechanisms during charging operation. In one implementation, an interior-most tubular conductor may be formed with a smaller effective cross-section relative to one or more adjacent tubular conductors to reduce eddy current effects that may arise due to proximity to the ferromagnetic element 212. Because magnetic flux density may be higher in regions closer to the ferromagnetic element, reducing conductor size in such regions may mitigate induced circulating currents and associated losses. This conductor sizing approach may further permit closer geometric integration between the coil and the ferromagnetic element without introducing unintended heating or efficiency-degrading effects, thereby supporting more uniform charging behavior across the transmitter panel.

The plurality of tubular conductors 210 forming the transmitter coil 208 generates a magnetic field that passes through the ferromagnetic element 212 during power transfer operations. The characteristics, size, and geometry of the ferromagnetic element 212 are selected to avoid magnetic saturation effects that may otherwise occur when the magnetic flux density within the ferromagnetic material exceeds the material's saturation threshold. Magnetic saturation may reduce the effective permeability of the ferromagnetic element 212, diminishing its ability to concentrate and direct magnetic flux toward the receiver coil and thereby reducing power transfer efficiency. The ferromagnetic element 212 is dimensioned such that the cross-sectional area and volume of ferromagnetic material are sufficient to carry the magnetic flux generated by the transmitter coil 208 without approaching saturation levels during high-power operation.

The ferromagnetic element 212 is further configured to minimize hysteresis losses and eddy current losses at the operating frequency of the transmitter coil 208. Hysteresis losses arise from the energy dissipated as the magnetic domains within the ferromagnetic material realign in response to the alternating magnetic field, with the magnitude of hysteresis losses dependent on the material properties and the frequency of the alternating current. Eddy current losses arise from circulating currents induced within the ferromagnetic material by the changing magnetic flux, with the magnitude of eddy current losses increasing with frequency and with the electrical conductivity of the ferromagnetic material. The ferromagnetic element 212 may comprise ferrite or other high-resistivity ferromagnetic materials that exhibit low electrical conductivity, thereby reducing eddy current losses at the high operating frequencies used for wireless power transfer. The geometry of the ferromagnetic element 212, including the protruded portions of the ferromagnetic element 214, is configured to provide adequate magnetic flux capacity while maintaining material volume within ranges that limit cumulative hysteresis and eddy current losses during sustained charging operations.

As further shown in FIG. 4, the transmitter panel assembly 200 includes a ferromagnetic element 212 arranged within the assembly. The ferromagnetic element 212 may comprise ferrite or other suitable ferromagnetic materials configured to concentrate and direct magnetic flux during power transfer operations. In various embodiments, the ferromagnetic element 212 may be provided as a plate structure arranged beneath the transmitter coil 208, with the plate structure extending across a substantial portion of the transmitter panel width 204 to provide a magnetic flux return path for the transmitter coil 208. The ferromagnetic element 212 comprises one or more protruded portions of the ferromagnetic element 214 arranged between at least two adjacent ones of the plurality of tubular conductors 210. The protruded portions of the ferromagnetic element 214 extend upward between the plurality of tubular conductors 210 to reduce the air gap between the transmitter panel assembly 200 and a corresponding receiver panel assembly mounted to a roadway vehicle. In some exemplary aspects, the ferromagnetic element 212 is elevated approximately 1 inch above the transmitter coil 208 on raised pedestals formed by the protruded portions of the ferromagnetic element 214. This elevated positioning lifts the magnetic material closer to a corresponding receiver coil to improve magnetic coupling and increase the allowable air gap by about an inch, thereby enhancing charging efficiency during inductive charging operations.

The selection of the ferromagnetic element 212 material may be based on engineering considerations that balance internal losses, saturation density, required material volume, cost, and other factors. In the embodiment represented in FIG. 4, the ferromagnetic element 212 includes ferrite material, which provides a favorable combination of low internal losses and adequate saturation density for the power transfer requirements of the system 100. In other embodiments, the ferromagnetic element 212 may comprise alternative ferromagnetic materials such as nano-crystalline materials. Nano-crystalline materials may exhibit higher internal losses compared to ferrite, but may require substantially less material volume to achieve comparable magnetic flux capacity due to higher saturation density characteristics. The selection between ferrite, nano-crystalline, or other ferromagnetic materials may be determined based on the specific performance requirements, dimensional constraints, thermal considerations, and cost targets for a particular implementation of the transmitter panel assembly 200.

With further reference to FIG. 4, the transmitter panel assembly 200 includes one or more support plates 216 arranged at regular intervals along the transmitter panel length 202 of the transmitter coil 208. Each support plate 216 extends transversely across the transmitter panel width 204 and is configured to receive at least a portion of the plurality of tubular conductors 210 extending therethrough. The support plates 216 include indentations that contact the plurality of tubular conductors 210 and provide mechanical stability and alignment for the coil components. At longitudinal ends of the plurality of tubular conductors 210, one or more bus bar assemblies 238 are positioned to provide electrical connections between different tubular conductors of the transmitter coil 208. Each bus bar assembly 238 includes planar conductive plates arranged to form continuous electrical paths through the transmitter coil 208, enabling efficient power distribution to the conductor arrangement within the transmitter panel assembly 200, while maximizing effective charging area.

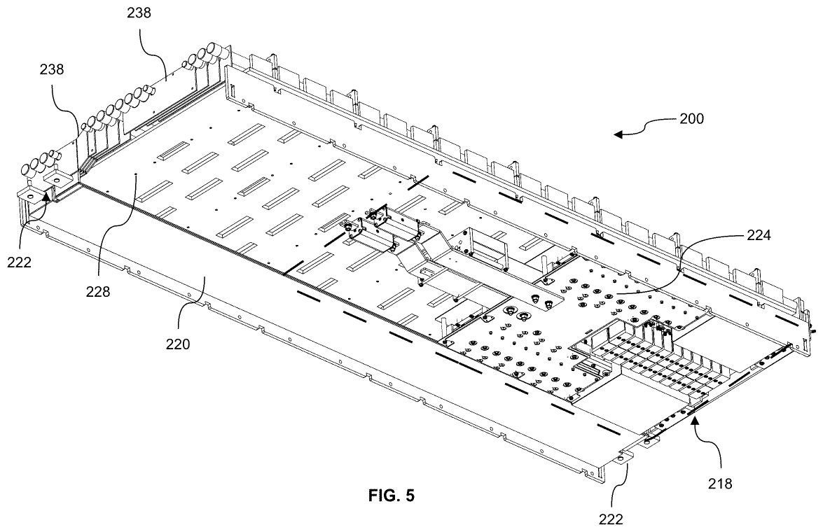

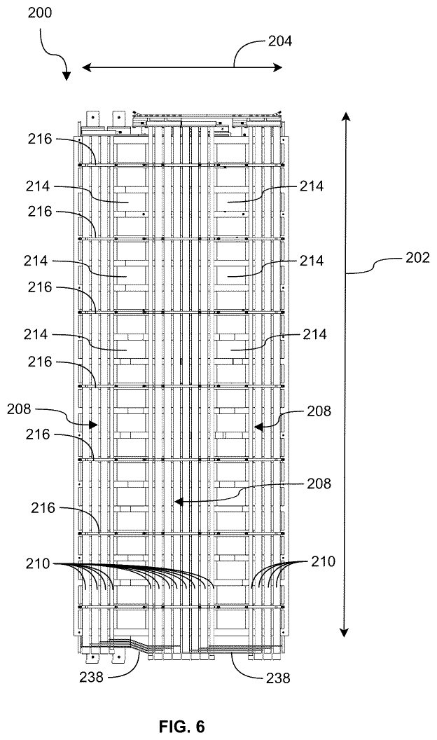

FIG. 5 illustrates a bottom perspective view of the transmitter panel assembly 200 for the dynamic wireless power transfer system 100, showing the underside structural arrangement and a power electronics assembly 218 positioned beneath the transmitter coil 208. The transmitter panel assembly 200 is divided conceptually into a top section and a bottom section, with the top section containing the transmitter coil 208, the ferromagnetic element 212, and the support plates 216, and the bottom section containing the power electronics assembly 218 and associated capacitors.

With continued reference to FIG. 5, the power electronics assembly 218 is electrically coupled to the transmitter coil 208 and configured to provide high-frequency alternating current to the transmitter coil 208. The power electronics assembly 218 is disposed within a magnetic field generated by the transmitter coil 208, positioned directly beneath the transmitter coil 208 and the ferromagnetic element 212 inside the concrete form of the roadway panel 102. In contrast to prior systems that position electronics outside the magnetic field to avoid induced currents and interference, the transmitter panel assembly 200 integrates the power electronics assembly 218 within the same enclosure as the transmitter coil 208. The power electronics assembly 218 includes high-current bus bars, water-cooled power capacitors, high-current transistors, diodes, and a microcontroller unit with control electronics arranged to deliver electrical power to the plurality of tubular conductors 210. The arrangement of components within the power electronics assembly 218 may be strictly arranged to minimize circuit inductance and the resulting radiated magnetic fields, which is achieved through close placement of current-carrying components to reduce loop areas and limit parasitic inductance that would otherwise contribute to electromagnetic interference within the transmitter panel assembly 200.

As further shown in FIG. 5, the power electronics assembly 218 includes a DC busbar 220 configured to receive and process direct current power from the off-board supply 106. DC panel external tabs 222 extend from the DC panel 220 at multiple locations along the transmitter panel assembly 200, with the DC panel external tabs 222 configured to receive power the neighboring panels when used in a plurality configuration, or from the off-board supply when used singularly in a static charging configuration. The DC panel external tabs 222 are visible at both a longitudinal end of the transmitter panel assembly 200 and along a lower edge thereof, providing electrical connection points for delivering direct current power to the power electronics assembly 218.

With further reference to FIG. 5, the power electronics assembly 218 includes a power plate 224 arranged within the power electronics assembly 218 and positioned adjacent to clusters of cylindrical capacitor components. The power plate 224 is arranged with various transistors and capacitors to deliver electrical power to the plurality of tubular conductors 210 of the transmitter coil 208.

In the exemplary panel represented in FIG. 5, the transmitter panel assembly 200 includes a shielding layer 228 disposed between the transmitter coil 208 and the power electronics assembly 218. The shielding layer 228 comprises aluminum and provides electromagnetic protection for the power electronics assembly 218 from the magnetic field generated by the transmitter coil 208 during power transfer operations. The shielding layer 228 extends across a substantial portion of the transmitter panel width 204 and the transmitter panel length 202, mitigating induced currents and interference that would otherwise affect the power electronics assembly 218 disposed within the magnetic field generated by the transmitter coil 208. This configuration allows all electronics and the transmitter coil 208 to form a single replaceable integrated assembly within the transmitter panel assembly 200, improving serviceability and enabling quick-swap replacement of the roadway panels 102 in case of failure.

FIG. 6 illustrates a top plan view of the transmitter panel assembly 200 for the dynamic wireless power transfer system 100, showing the internal arrangement of components within the panel structure. The transmitter coil 208 is positioned within the transmitter panel assembly 200 and extends along the transmitter panel length 202. The transmitter coil 208 comprises the plurality of tubular conductors 210 arranged in multiple parallel rows extending across the transmitter panel width 204. As described previously, each of the plurality of tubular conductors 210 defines an interior channel configured to receive a cooling fluid therethrough for thermal management during power transfer operations. The plurality of tubular conductors 210 allows water cooling through the interior channels to address higher heat loads associated with significantly higher power transfer than prior systems, enabling sustained high-power operation and extending the duty cycle of the transmitter panel assembly 200.

As further shown in FIG. 6, the protruded portions of the ferromagnetic element 214 are arranged between adjacent tubular conductors of the plurality of tubular conductors 210, the ferromagnetic protrusions distributed along the transmitter panel length 202. The protruded portions of the ferromagnetic element 214 extend upward between the plurality of tubular conductors 210 to reduce the air gap between the transmitter panel assembly 200 and a corresponding receiver panel assembly mounted to a roadway vehicle, thereby enhancing magnetic coupling efficiency during inductive charging operations. The protruded portions of the ferromagnetic element 214 similarly extend along the transmitter panel length 202 through the transmitter panel assembly 200, maintaining alignment with the plurality of tubular conductors 210 and contributing to the magnetic-field characteristics of the system 100.

With further reference to FIG. 6, the support plates 216 are arranged at regular intervals along the transmitter panel length 202 of the transmitter coil 208, with multiple instances of reference numeral 216 positioned on the left side of the figure indicating the various support plate locations. Each support plate 216 extends transversely across the transmitter panel width 204 and is configured to receive at least a portion of the plurality of tubular conductors 210 extending therethrough. The support plates 216 include indentations that contact the plurality of tubular conductors 210 and provide mechanical stability and alignment for the coil components within the transmitter panel assembly 200. At the lower longitudinal end of the plurality of tubular conductors 210, the bus bar assemblies 238 are positioned on both sides, allowing the electrical connection structures that provide electrical connections between different tubular conductors of the transmitter coil 208.

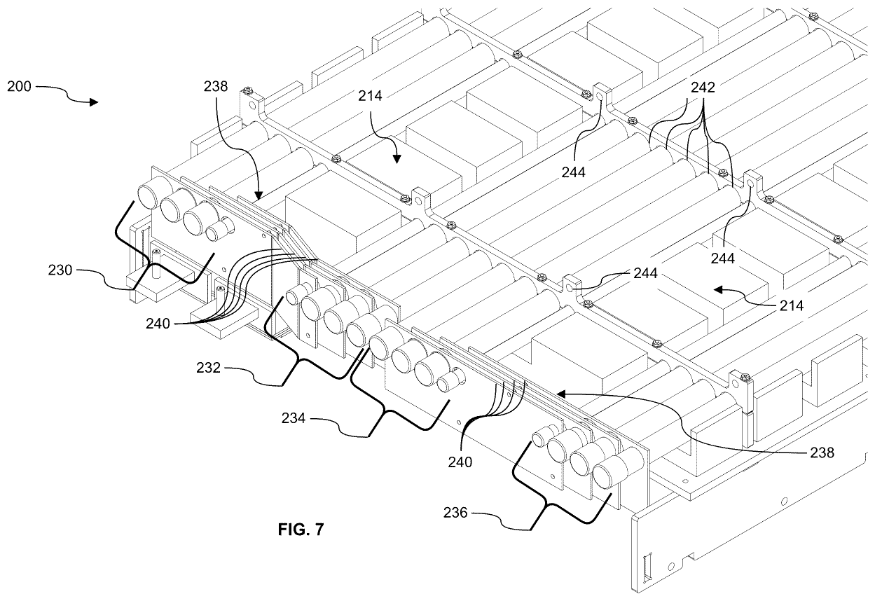

FIG. 7 illustrates a magnified perspective view of a longitudinal end of the transmitter panel assembly 200 for the dynamic wireless power transfer system 100, showing the arrangement of the plurality of tubular conductors 210 and the bus bar assemblies 238 that form the transmitter coil 208. The view is taken from an elevated angle that reveals the structural configuration of the conductor connections and supporting framework at the longitudinal end of the transmitter panel assembly 200.

With continued reference to FIG. 7, the plurality of tubular conductors 210 are arranged in multiple parallel rows extending horizontally across the transmitter panel width 204. The plurality of tubular conductors 210 are organized into distinct subsets, including a first subset of tubular conductors 230 and a second subset of tubular conductors 232 positioned in an upper grouping, and a third subset of tubular conductors 234 and a fourth subset of tubular conductors 236 positioned in a lower grouping. In the embodiment represented in FIG. 7, the plurality of tubular conductors 210 comprises the first subset of tubular conductors 230 and the second subset of tubular conductors 232, with the protruded portions of the ferromagnetic element 214 arranged between the first subset of tubular conductors 230 and the second subset of tubular conductors 232 along the longitudinal length thereof. Similarly, the third subset of tubular conductors 234 and the fourth subset of tubular conductors 236 are separated by additional protruded portions of the ferromagnetic element 214 extending along the longitudinal length of the transmitter panel assembly 200.

As further shown in FIG. 7, adjacent ones of the first subset of tubular conductors 230 and adjacent ones of the second subset of tubular conductors 232 do not include the protruded portions of the ferromagnetic element 214 therebetween. The protruded portions of the ferromagnetic element 214 are positioned between the first subset of tubular conductors 230 and the second subset of tubular conductors 232, and between the third subset of tubular conductors 234 and the fourth subset of tubular conductors 236, rather than between adjacent conductors within each subset. The tubular conductors positioned directly adjacent to the protruded portions of the ferromagnetic element 214 have smaller diameters relative to the larger diameters of the other tubular conductors not arranged directly adjacent to the protruded portions of the ferromagnetic element 214. The various tubular conductors, due to their differing magnetic environments relative to the ferromagnetic element 212, generate differing amounts of internal eddy currents within their structure, resulting in varying electrical losses across the conductor arrangement. Tubular conductors positioned closer to the protruded portions of the ferromagnetic element 214 experience higher magnetic flux density, which may induce greater eddy current losses within the conductor material. The use of smaller diameter tubular conductors astride the protruded portions of the ferromagnetic element 214 reduces the cross-sectional area available for eddy current circulation, thereby minimizing these losses while maintaining efficient current-carrying capacity for the transmitter coil 208. This configuration allows the at least two adjacent ones of the plurality of tubular conductors 210 astride the protruded portions of the ferromagnetic element 214 to comprise a diameter smaller than the others of the plurality of tubular conductors 210.

With further reference to FIG. 7, a bus bar assembly, specifically two bus bar assemblies 238, are electrically coupled to the plurality of tubular conductors 210 at the longitudinal end of the transmitter panel assembly 200. A first bus bar assembly 238 provides electrical connection between the first subset of tubular conductors 230 and the second subset of tubular conductors 232, while a second bus bar assembly of the at least two bus bar assemblies 238 provides electrical connection between the third subset of tubular conductors 234 and the fourth subset of tubular conductors 236. Each bus bar assembly 238 comprises a planar conductive plate 240 positioned at a respective end of at least two of the plurality of tubular conductors 210 to form an electrical path through the transmitter coil 208. The planar conductive plates 240 are arranged in a staggered configuration to provide electrical interconnection between the various conductor groups, with the staggered arrangement enabling efficient electrical connection of tubular conductors within each connected subset while maintaining electrical independent between individual tubular conductors. The planar conductive plates at the U-turn connections of the longitudinal ends of the plurality of tubular conductors permit each tubular conductor to extend much closer to the physical edge of the transmitter panel assembly 200 compared to thick wires with large bend radii that would otherwise be required to complete the turn of the transmitter coil 208. This configuration minimizes dead zones between sequential roadway panels 102 when the roadway panels 102 are arranged in the end-to-end configuration within the charged pavement 166 sections.

In the embodiment represented in FIG. 7, the planar conductive plates 240 form flat-plate U-turn connections at the longitudinal end of the plurality of tubular conductors 210. The flat conductive plates at the U-turn connections allow the plurality of tubular conductors 210 to extend much closer to the physical edge of the transmitter panel assembly 200 compared to thick wires with large bend radii that would otherwise be required to complete the turn of the transmitter coil 208. This configuration minimizes dead zones between sequential roadway panels 102 when the roadway panels 102 are arranged in the end-to-end configuration within the charged pavement 116 sections. The planar conductive plates 240 positioned at the respective ends of the plurality of tubular conductors 210 enable the transmitter coil 208 to extend substantially the entire transmitter panel length 202, thereby maximizing the effective charging distance of each roadway panel 102 in the direction of vehicle travel.

As further shown in FIG. 7, the transmitter panel assembly 200 includes the support plates 216 configured to receive portions of the plurality of tubular conductors 210 extending therethrough. Each support plate 216 includes a support plate indention 242 where the plurality of tubular conductors 210 pass through the support plate 216, with the support plate indentions 242 maintaining the positioning and alignment of the plurality of tubular conductors 210 within the transmitter panel assembly 200. The support plates 216 also include a support plate aperture 244 defined by raised tabs that allow reinforcement bars to be positioned within the transmitter panel assembly 200. The support plate apertures 244 enable reinforcement bars to be mechanically attached to the support plates 216 rather than being suspended separately during casting, providing both structural synergy and reliable alignment during casting of the roadway panels 102 into concrete. This configuration eliminates standard rebar chairs and ties, simplifying assembly and improving rigidity of the transmitter panel assembly 200 when embedded within the roadway pavement 104.

In various embodiments, the reinforcement bars positioned within the support plate apertures 244 comprise fiberglass rebar instead of traditional steel rebar. In other aspects, the reinforcement bars may include other non-magnetic materials options, including carbon fiber. The fiberglass rebar provides concrete reinforcement while avoiding electromagnetic interference with the transmitter coil 208 and the ferromagnetic element 212 during power transfer operations. Traditional steel rebar may interact with the magnetic field generated by the transmitter coil 208, potentially causing induced currents, heating, or interference with the wireless power transfer characteristics of the transmitter panel assembly 200. The fiberglass rebar is non-conductive and non-magnetic, thereby eliminating these potential interactions while still providing the structural reinforcement required for the concrete body of the roadway panel 102. The integration of the fiberglass rebar with the support plates 216 provides both structural synergy and reliable alignment during casting, as the rebar is mechanically attached to existing internal supports within the electrical assembly rather than being suspended separately using standard rebar chairs and ties.

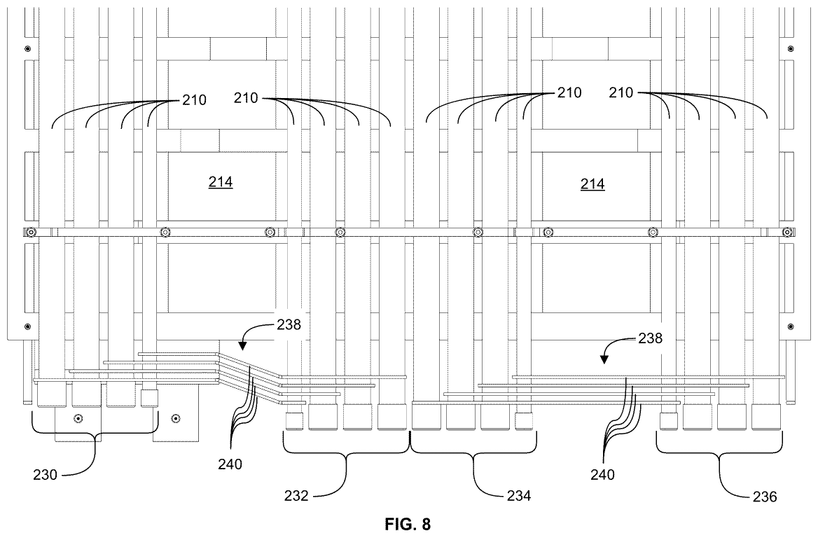

FIG. 8 illustrates a top plan view of a magnified end portion of the transmitter panel assembly 200 for the dynamic wireless power transfer system 100, showing the arrangement of the bus bar assemblies 238 that provide electrical connections between the plurality of tubular conductors 210 of the transmitter coil 208. The protruded portions of the ferromagnetic element 214 are positioned between adjacent groups of the plurality of tubular conductors 210.

With continued reference to FIG. 8, the plurality of tubular conductors 210 may be organized into various distinct subsets, with each subset characterized by adjacent tubular conductors without protruded portions of the ferromagnetic element 214 there between. As described previously, the first subset of tubular conductors 230 and the second subset of tubular conductors 232 are separated by the protruded portions of the ferromagnetic element 214, and the third subset of tubular conductors 234 and the fourth subset of tubular conductors 236 are similarly separated by the protruded portions of the ferromagnetic element 214.

As further shown in FIG. 8, a first bus bar assembly of the at least two bus bar assemblies 238 is arranged at a first end of both the first subset of tubular conductors 230 and the second subset of tubular conductors 232. The first bus bar assembly 238 provides electrical connection between the first subset of tubular conductors 230 and the second subset of tubular conductors 232. A second bus bar assembly of the at least two bus bar assemblies 238 provides electrical connection between the third subset of tubular conductors 234 and the fourth subset of tubular conductors 236. Each bus bar assembly 238 comprises the planar conductive plates 240 arranged to form continuous electrical paths through the transmitter coil 208.

With further reference to FIG. 8, the planar conductive plates 240 of each bus bar assembly 238 comprise a plurality of conductive plates forming a progressively staggered interconnect arrangement. In the embodiment represented in FIG. 8, each conductive plate of the plurality of conductive plates electrically couples a different overlapping subset of conductors of the first subset of tubular conductors 230 with a different overlapping subset of the second subset of tubular conductors 232. The progressively staggered interconnect arrangement enables efficient electrical interconnection between the tubular conductors of each connected subset by providing overlapping electrical connections that distribute current across the plurality of tubular conductors 210.

The staggered interconnect arrangement need not be progressive in all embodiments, and different planar conductive plate configurations may also be provided depending upon the specific conductor arrangement and electrical requirements of the transmitter coil 208. Alternative configurations of the planar conductive plates 240 may include uniform staggering, non-uniform staggering, or other interconnect patterns that achieve the desired electrical coupling between the tubular conductors of adjacent subsets.

In some cases, the planar conductive plates 240 of the bus bar assemblies 238 may be substantially flat, such as the bus bar assembly 238 connecting the third subset of tubular conductors 234 and the fourth subset of tubular conductors 236. In other cases, the planar conductive plates 240 may include deviations from a single plane depending upon relative geometries of the connected tubular conductors, such as the first bus bar assembly 238 connecting the first subset of tubular conductors 230 and the second subset of tubular conductors 232. The deviations from a single plane accommodate differences in vertical positioning or diameter of the plurality of tubular conductors 210 within each subset, allowing the planar conductive plates 240 to maintain electrical contact with tubular conductors arranged at different elevations or with different cross-sectional profiles. The structural framework of the transmitter panel assembly 200 includes longitudinal side rails and cross members visible throughout the assembly in FIG. 8, with small circular features indicating fastener locations that secure the various structural elements together.

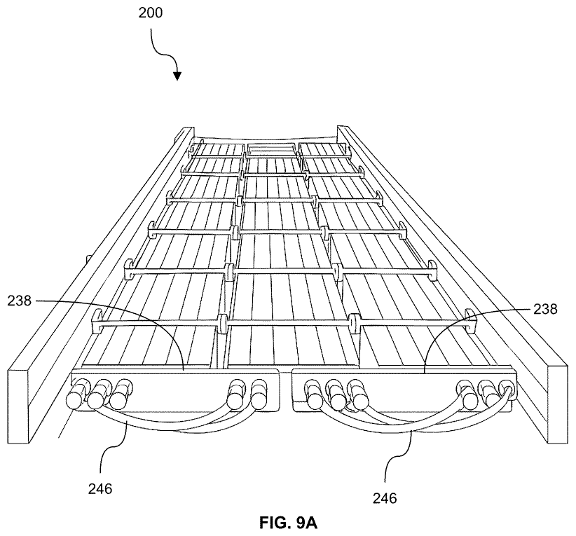

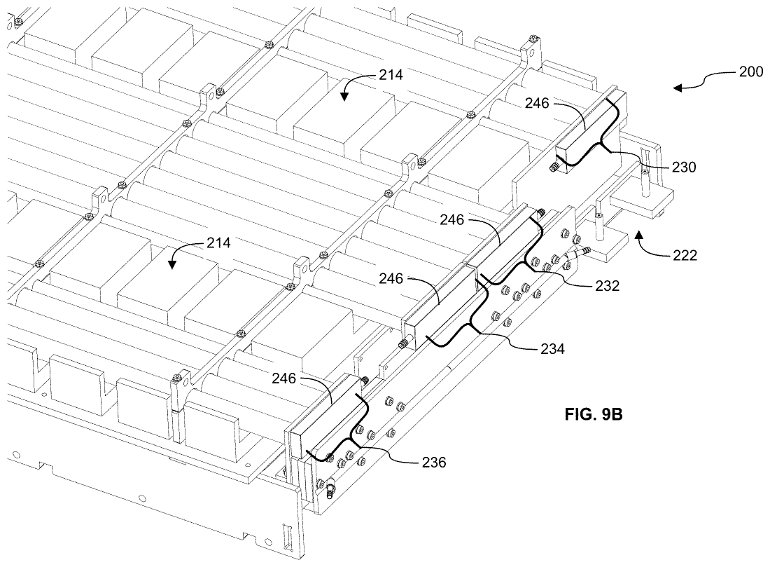

FIG. 9A illustrates an isometric perspective view of a longitudinal end of the transmitter panel assembly 200 for the dynamic wireless power transfer system 100, specifically showing the arrangement of cooling fluid connections between the plurality of tubular conductors 210 of the transmitter coil 208. Arranged at the terminating ends of the plurality of tubular conductors 210, a plurality of cooling fluid connections 246 are visible as curved tubing elements that loop downward in a U-shaped configuration and back upward. The cooling fluid connections 246 establish fluid routing pathways between adjacent tubular conductors of the plurality of tubular conductors 210, allowing cooling fluid to flow from one tubular conductor through the curved connection and into an adjacent tubular conductor, creating a continuous fluid path through multiple conductors of the transmitter coil 208.

In the embodiment represented in FIG. 9A, for each of the plurality of tubular conductors 210, a cooling fluid connection 246 is provided between a single one of the first subset of tubular conductors 230 and a single one of the second subset of tubular conductors 232. The cooling fluid connections 246 are organized such that tubular conductors from different subsets of the plurality of tubular conductors 210 are fluidly connected to one another, enabling a compact both passive and active cooling design for the transmitter panel assembly 200. This arrangement allows cooling fluid to circulate through the interior channels of the plurality of tubular conductors 210 to dissipate heat generated during high-power wireless charging operations.

The transmitter panel assembly 200 may also use adiabatic cooling where the copper of the plurality of tubular conductors 210 and the ferrite of the ferromagnetic element 212 absorb heat over a short activation window of milliseconds while a truck passes overhead. The thermal mass of the copper and ferrite materials, as well as in some instances in-situ or passive cooling fluid within the transmitter panel assembly 200 is sufficient to absorb the heat generated during the brief power transfer event without requiring active cooling or pumps in the roadway. This adiabatic cooling approach leverages the intermittent nature of dynamic wireless power transfer, where each roadway panel 102 is activated for only a short duration as a vehicle traverses the charged pavement 116 section. The heat absorbed by the copper and ferrite mass during the activation window dissipates passively between vehicle passes, maintaining thermal equilibrium within the transmitter panel assembly 200 without continuous active cooling infrastructure embedded in the roadway pavement 104.

The cooling configuration of the transmitter panel assembly 200 is adapted based on the intended operational mode. In dynamic or in-motion charging applications where each transmitter panel is activated for brief intervals as vehicles pass overhead, the thermal mass of the copper of the plurality of tubular conductors 210 and the ferrite of the ferromagnetic element 212 is sufficient to absorb heat generated during the activation window without requiring active cooling fluid circulation. In such configurations, the interior channels of the plurality of tubular conductors 210 contain static cooling fluid that provides additional thermal mass, or the interior channels remain unfilled. In static or semi-static charging applications where transmitter panels are activated for extended periods, active cooling fluid circulation through the interior channels of the plurality of tubular conductors 210 is provided to dissipate heat during sustained operation. The command and control system is configured to selectively activate or deactivate cooling fluid circulation based on the detected operational mode, anticipated activation duration, or measured thermal conditions within the transmitter panel assembly 200. In various embodiments, a single transmitter panel assembly 200 supports both passive thermal mass cooling for dynamic operations and active fluid cooling for static or semi-static operations, with the cooling mode selected through software configuration rather than hardware modification.

FIG. 9B illustrates an isometric perspective view of a different longitudinal end of the transmitter panel assembly 200 for the dynamic wireless power transfer system 100, specifically showing exemplary manifolds providing fluid connection between different subsets of the plurality of tubular conductors 210 of the transmitter coil 208. The view is taken from an elevated angle that reveals the parallel arrangement of the plurality of tubular conductors 210 extending along the transmitter panel assembly 200, along with the manifold-based fluid routing infrastructure positioned at the longitudinal end of the transmitter panel assembly 200.

With continued reference to FIG. 9B, the plurality of tubular conductors 210 are organized in multiple parallel rows, with the protruded portions of the ferromagnetic element 214 visible between adjacent rows of the plurality of tubular conductors 210. As described previously, each tubular conductor of the plurality of tubular conductors 210 has a cylindrical profile suitable for carrying high-frequency alternating current and includes an interior channel configured to receive cooling fluid for thermal management during power transfer operations. The plurality of tubular conductors 210 are organized into the first subset of tubular conductors 230, the second subset of tubular conductors 232, the third subset of tubular conductors 234, and the fourth subset of tubular conductors 236, with each subset indicated by a curly bracket identifying the grouping of conductors within that subset. The first subset of tubular conductors 230 and the second subset of tubular conductors 232 are separated along the longitudinal length by the protruded portions of the ferromagnetic element 214, and the third subset of tubular conductors 234 and the fourth subset of tubular conductors 236 are similarly separated by additional protruded portions of the ferromagnetic element 214.

As further shown in FIG. 9B, at the longitudinal end of the transmitter panel assembly 200, the cooling fluid connections 246 are visible as manifolds providing fluid connection between different subsets of the plurality of tubular conductors 210. Unlike the curved tubing connections shown in FIG. 9A, the cooling fluid connections 246 in FIG. 9B comprise manifolds with a more flat, flush design that connect the interiors of at least two tubular conductors from different subsets of the plurality of tubular conductors 210. The manifold configuration provides an alternative to the U-shaped curved tubing elements, with the flat flush design reducing the vertical profile of the fluid routing infrastructure at the longitudinal end of the transmitter panel assembly 200. The manifold arrangement additionally facilitates thermal distribution across the transmitter coil 208 by sharing heated cooling fluid between different coil sections. As cooling fluid circulates through the plurality of tubular conductors 210, the manifolds at one longitudinal end combine fluid from different subsets of tubular conductors, creating a homogeneous mixture of heated fluid that is redistributed across the coil sections. This thermal sharing arrangement promotes uniform heat distribution throughout the copper mass of the plurality of tubular conductors 210, reducing localized temperature variations and improving overall thermal management of the transmitter panel assembly 200.

With further reference to FIG. 9B, the manifold arrangement of the cooling fluid connections 246 enables efficient passive cooling by establishing fluid pathways between tubular conductors of different subsets of the plurality of tubular conductors 210. The manifolds allow cooling fluid to circulate through the interior channels of the plurality of tubular conductors 210 to dissipate heat generated during high-power wireless charging operations. The flat flush design of the manifolds facilitates integration within the precast concrete of the roadway panels 102 by minimizing protrusions that would otherwise extend beyond the envelope of the transmitter panel assembly 200. This configuration provides a compact design alternative to the curved tubing connections, accommodating the strict vertical height limit of approximately 9 inches of total thickness available within the roadway panels 102.

As further shown in FIG. 9B, the DC panel external tabs 222 are visible extending from the transmitter panel assembly 200 at the longitudinal end. The DC panel external tabs 222 are configured to receive power from the off-board supply 106, providing electrical connections for delivering direct current power to the power electronics assembly 218 within the transmitter panel assembly 200.

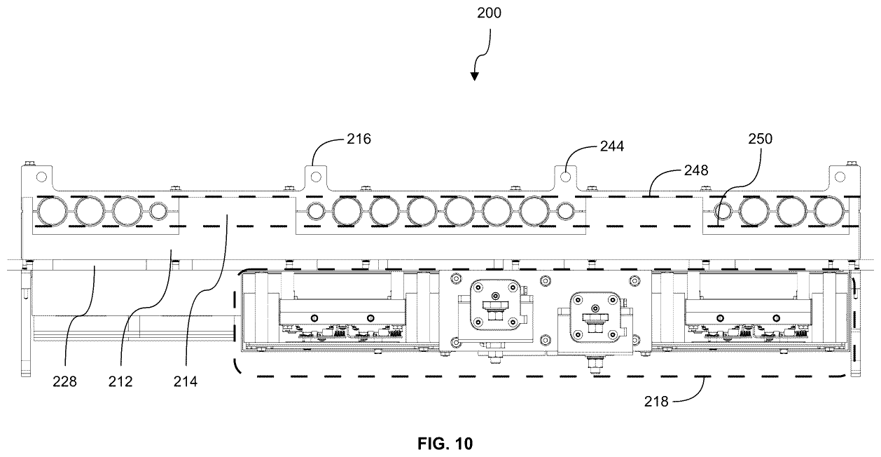

FIG. 10 illustrates a side sectional view of the transmitter panel assembly 200 for the dynamic wireless power transfer system 100, showing the internal arrangement of components within the panel structure from a lateral perspective. In the embodiment represented in FIG. 10, the transmitter panel assembly 200 presents an elongated horizontal configuration that reveals the vertical layering and spatial relationships between the various functional elements contained within the panel. The side sectional view depicts the segmentation of the transmitter panel assembly 200 into a top portion including the transmitter coil 208, the support plates 216, and the ferromagnetic element 212, and a bottom portion including the power electronics assembly 218 with the shielding layer 228 arranged between the top and bottom portions.

With continued reference to FIG. 10, the upper portion of the transmitter panel assembly 200 displays a row of circular cross-sections arranged horizontally across the transmitter panel length 202, representing the plurality of tubular conductors 210 that form the transmitter coil 208. The plurality of tubular conductors 210 are shown in profile, revealing the cylindrical geometry and interior channels configured to receive cooling fluid for thermal management during power transfer operations. A top surface of tubular conductors 248 and a bottom surface of tubular conductors 250 are indicated by dashed horizontal lines extending across the transmitter panel width 204, defining the vertical extent of the conductor arrangement within the transmitter panel assembly 200.

As further shown in FIG. 10, the ferromagnetic element 212 is visible extending between adjacent tubular conductors of the plurality of tubular conductors 210. The protruded portions of the ferromagnetic element 214 rise above a plane defined by the bottom surface of tubular conductors 250, and in some instances the protruded portions of the ferromagnetic element 214 extend above a plane defined by the top surface of tubular conductors 248. This elevated positioning of the ferromagnetic element 212 reduces the air gap between the transmitter panel assembly 200 and a vehicle-mounted receiver assembly, enhancing magnetic coupling efficiency during wireless power transfer operations. As described previously, the protruded portions of the ferromagnetic element 214 are arranged between at least two adjacent ones of the plurality of tubular conductors 210, with the protruded portions of the ferromagnetic element 214 elevating the ferromagnetic element 212 above the plane defined by the bottom surface of tubular conductors 250 and above the plane defined by the top surface of tubular conductors 248.

With further reference to FIG. 10, the support plates 216 are visible at intervals along the transmitter panel assembly 200, extending transversely across the transmitter panel width 204 and configured to receive portions of the plurality of tubular conductors 210 extending therethrough. Each support plate 216 extends across at least a portion of the transmitter coil 208 and comprises a first indentation configured to contact each of the plurality of tubular conductors 210 across which the support plate 216 extends. The support plate apertures 244 are indicated at the upper edge of the transmitter panel assembly 200, defined by raised tabs that allow reinforcement bars to be positioned within the transmitter panel assembly 200 for integration with precast concrete roadway structures. Each support plate 216 comprises a second indentation configured to contact a reinforcement bar, with the reinforcement bars mechanically attached to the support plates 216 rather than being suspended separately during casting. This configuration eliminates standard rebar chairs and ties that would otherwise be used to position reinforcement bars within the concrete form, simplifying assembly and improving rigidity of the transmitter panel assembly 200 when embedded within the roadway pavement 104.

As further shown in FIG. 10, the lower portion of the transmitter panel assembly 200 contains the power electronics assembly 218, which is positioned directly beneath the transmitter coil 208 and the ferromagnetic element 212 within a dashed rectangular outline. The power electronics assembly 218 includes rectangular housing structures representing capacitors, transistors, and control electronics configured to generate the high-frequency alternating current supplied to the transmitter coil 208. The shielding layer 228 is disposed between the upper portion containing the transmitter coil 208 and the ferromagnetic element 212 and the lower portion containing the power electronics assembly 218, protecting the power electronics assembly 218 from the electromagnetic field generated by the transmitter coil 208 during operation while allowing the electronics to remain within the compact vertical envelope of the transmitter panel assembly 200. In various aspects, the shielding layer 228 may include a cement board layer or other structurally rigid layer configured to bond with the concrete poured around the transmitter panel assembly 200 during casting. The cement board layer may provide structural rigidity to the transmitter panel assembly 200 during assembly and handling prior to casting, and may further enhance mechanical integration between the shielding layer 228 and the concrete body after casting.

In the embodiment represented in FIG. 10, the bus bar assemblies 238 have a U-shaped architecture configured to route coil connections from the plurality of tubular conductors 210 down into the electronics stack of the power electronics assembly 218 below the transmitter coil 208. The U-shaped bus bar architecture provides electrical pathways that extend from the longitudinal ends of the plurality of tubular conductors 210 downward through the shielding layer 228 and into the power electronics assembly 218, enabling high-current connections between the transmitter coil 208 and the power electronics components disposed in the bottom portion of the transmitter panel assembly 200. This U-shaped configuration accommodates the strict vertical height limit of approximately 9 inches or less of total thickness available within the roadway panels 102 by routing the electrical connections vertically rather than horizontally, thereby maintaining the compact profile of the transmitter panel assembly 200 while providing efficient power distribution to the plurality of tubular conductors 210.

In various embodiments, the transmitter panel assembly 200 includes a concrete body encasing the transmitter coil 208, the bus bar assemblies 238, the power electronics assembly 218, and the ferromagnetic element 212. The concrete body forms the structural roadway surface of each roadway panel 102 and provides mechanical protection for the internal components of the transmitter panel assembly 200 during vehicle loading and environmental exposure. The concrete body is cast around the transmitter panel assembly 200 to a total thickness of approximately 9 to 10 inches, with the transmitter coil 208, the bus bar assemblies 238, the power electronics assembly 218, and the ferromagnetic element 212 embedded within the concrete form to create a unitary precast roadway inductive charging panel.

The concrete body includes reinforcement bars for structural reinforcement of the precast roadway panel 102. In the embodiment described herein, the reinforcement bars comprise fiberglass rebar instead of traditional steel rebar. The fiberglass rebar provides concrete reinforcement while avoiding electromagnetic interference with the transmitter coil 208 and the ferromagnetic element 212 during power transfer operations. Traditional steel rebar may interact with the magnetic field generated by the transmitter coil 208, potentially causing induced currents, heating, or interference with the wireless power transfer characteristics of the transmitter panel assembly 200. The fiberglass rebar is non-conductive and non-magnetic, thereby eliminating these potential interactions while still providing the structural reinforcement for the concrete body of the roadway panel 102.

As described previously, the support plates 216 include the support plate apertures 244 configured to receive the reinforcement bars, with the reinforcement bars mechanically attached to the support plates 216 rather than being suspended separately during casting. The fiberglass rebar is positioned within the support plate apertures 244 and secured to the support plates 216, providing both structural synergy and reliable alignment during casting of the concrete body around the transmitter panel assembly 200.

The power electronics assembly 218 includes capacitors that are custom-selected to fit within the strict vertical height limit of approximately 9 inches available within the roadway panel 102. The capacitors comprise short water-cooled capacitors that have a reduced vertical profile compared to standard capacitor configurations. The short water-cooled capacitors are selected to accommodate the compact vertical envelope of the transmitter panel assembly 200 while providing the capacitance values and current-handling capability for high-power wireless charging operations. The water-cooled configuration of the capacitors enables thermal management of the power electronics assembly 218 by circulating cooling fluid through or around the capacitor housings to dissipate heat generated during high-frequency switching operations. The custom selection of short water-cooled capacitors, along with creative orientation of other power electronics components within the power electronics assembly 218, enables the transmitter panel assembly 200 to fit within the strict dimensional constraints of the roadway panel 102 while maintaining the power handling capability for dynamic wireless power transfer to heavy-duty trucks.

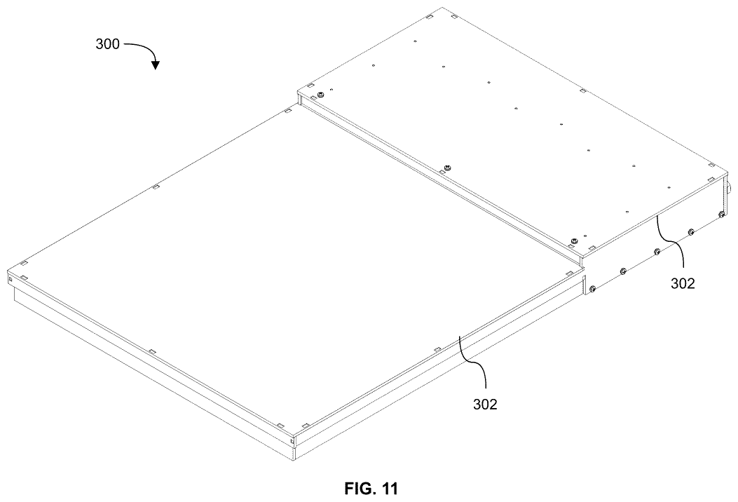

FIG. 11 illustrates an isometric perspective view of a receiver panel assembly 300 for the dynamic wireless power transfer system 100, configured for mounting beneath a vehicle to inductively receive power from the plurality of roadway panels 102 arranged in the end-to-end configuration within the charged pavement 116 sections. The receiver panel assembly 300 forms part of a vehicle-mounted receiver assembly configured to be positioned beneath a vehicle and to inductively receive power from the plurality of precast roadway inductive charging panels. In the embodiment represented in FIG. 11, the receiver panel assembly 300 presents a rectangular configuration with a shallow tray-like enclosure formed by raised peripheral edges extending around the perimeter of the receiver panel assembly 300.

With continued reference to FIG. 11, the receiver panel assembly 300 may include a receiver panel housing 302 that defines the structural enclosure of the receiver panel assembly 300. The receiver panel housing 302 includes walls extending from a base panel to form the tray-like configuration, providing containment for internal components including a receiver coil, ferromagnetic materials, and resonant power circuitry that are encased within the receiver panel housing 302.

As further shown in FIG. 11, the upper surface of the receiver panel assembly 300 features a flat planar region that serves as the primary structural surface, with multiple small circular features distributed across the upper surface in a regular pattern representing mounting holes or fastener locations that secure internal components to the panel structure. Along the edges of the receiver panel assembly 300, regularly spaced mounting tabs or flanges extend outward from the receiver panel housing 302, providing attachment points for securing the receiver panel assembly 300 to an underside of a vehicle chassis. The mounting tabs facilitate integration of the receiver panel assembly 300 with the vehicle, positioning the receiver panel assembly 300 at an air gap of approximately 10 inches from the roadway surface during operation.

With further reference to FIG. 11, at one end of the receiver panel assembly 300, a raised section extends across the width of the receiver panel assembly 300, containing connection interfaces for fluid and electrical connections. The raised section includes mounting brackets visible at the corners that facilitate integration with vehicle systems including a cooling loop and electrical power connections to route received power to a vehicle battery system. The peripheral frame structure of the receiver panel housing 302 includes corner brackets with visible fastener holes that provide structural rigidity to the overall assembly of the receiver panel assembly 300.

In the embodiment represented in FIG. 11, the frame edges of the receiver panel housing 302 feature a stepped profile that creates the shallow tray configuration, with the raised edges providing containment for internal components of the receiver panel assembly 300. The interior volume defined by the receiver panel housing 302 is configured such that upon manufacture the interior volume is filled with epoxy or other setting material to prevent movement of internal components of the receiver panel assembly 300 during movement of a roadway vehicle. After assembly, the receiver panel assembly 300 may be filled with epoxy, sealed, and installed under the vehicle with the air gap from the roadway surface. The epoxy encapsulation secures the internal components including the receiver coil, ferromagnetic materials, and resonant power circuitry within the receiver panel housing 302, providing mechanical stability and environmental protection during vehicle operation and inductive charging from the transmitter panel assembly 200 embedded within the roadway panels 102.

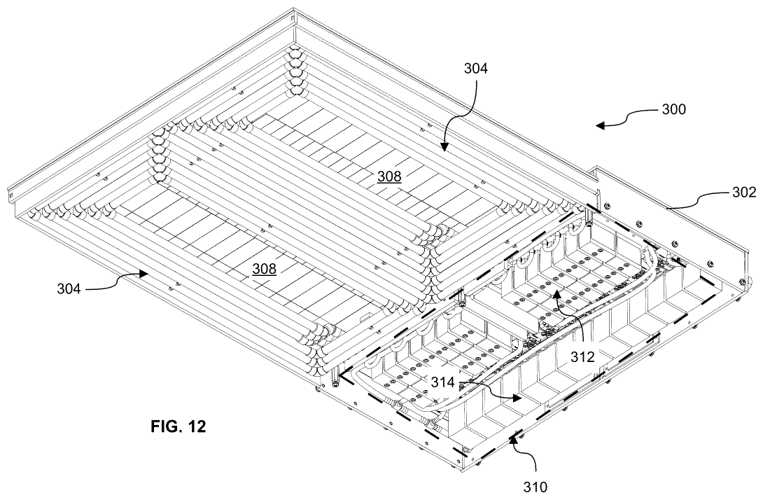

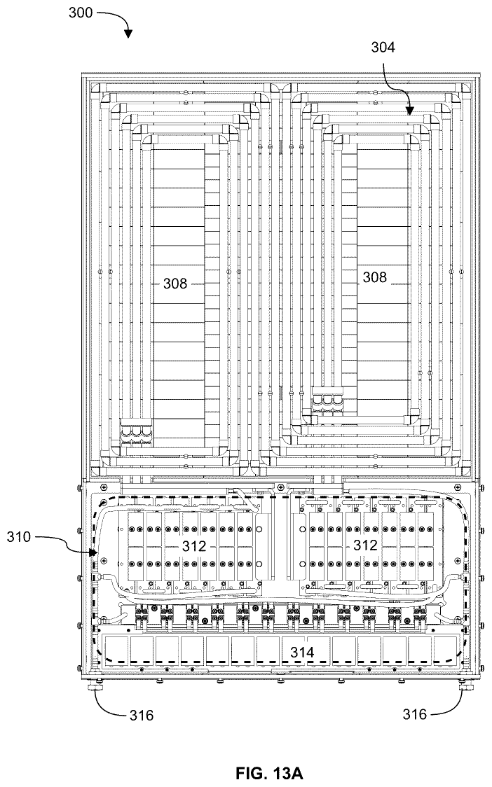

FIG. 12 illustrates a bottom perspective view of the receiver panel assembly 300 for the dynamic wireless power transfer system 100, with a bottom panel of the receiver panel housing 302 removed to reveal the internal arrangement of components within the receiver panel assembly 300. The receiver panel assembly 300 is configured for mounting beneath a vehicle to inductively receive power from the plurality of roadway panels 102 arranged in the end-to-end configuration within the charged pavement 116 sections. In the embodiment represented in FIG. 12, the receiver panel assembly 300 presents an elongated rectangular configuration with raised peripheral edges forming a shallow tray-like enclosure.

With continued reference to FIG. 12, the receiver panel housing 302 is visible along the right edge of the receiver panel assembly 300, comprising the structural frame that defines the interior volume of the receiver panel assembly 300. As described previously, upon manufacture the interior volume is filled with epoxy or other setting material to prevent movement of internal components during vehicle operation. The receiver panel assembly 300 includes a receiver coil 304. The receiver coil 304 is selectively electromagnetically coupleable to the transmitter coil 208 of at least one of the plurality of roadway panels 102 when the vehicle traverses the charged pavement 116 sections.

As further shown in FIG. 12, the receiver coil 304 comprises a plurality of receiver tubular conductors 306 arranged in multiple parallel rows extending horizontally across the width of the receiver panel assembly 300. Each receiver tubular conductor of the plurality of receiver tubular conductors 306 defines an interior channel configured to receive a cooling fluid from a cooling system of the vehicle for thermal management during power transfer operations. The plurality of receiver tubular conductors 306 are organized to form an electrical path configuration that differs from the transmitter coil 208 arrangement, with the plurality of receiver tubular conductors 306 arranged in close proximity to one another. In the embodiment represented in FIG. 12, the receiver coil 304 provides an inward to outward or outward to inward spiral path of the plurality of receiver tubular conductors 306, creating a spiral electrical path configuration that enables efficient electromagnetic coupling with the transmitter coil 208 embedded within the roadway panels 102.

With further reference to FIG. 12, the receiver panel assembly 300 includes a receiver ferromagnetic material 308 positioned between adjacent sections of the receiver coil 304. Two instances of reference numeral 308 indicate the elongated ferromagnetic structures extending along portions of the plurality of receiver tubular conductors 306. The receiver ferromagnetic material 308 is disposed between at least two adjacent ones of the plurality of receiver tubular conductors 306, enhancing magnetic coupling with the transmitter coil 208 embedded in the roadway panels 102 below by concentrating and directing magnetic flux during inductive power transfer. The receiver ferromagnetic material 308 functions similarly to the ferromagnetic element 212 of the transmitter panel assembly 200, improving the efficiency of electromagnetic coupling between the receiver coil 304 and the transmitter coil 208 during wireless power transfer operations.

As further shown in FIG. 12, the receiver panel assembly 300 includes a receiver resonant power circuitry 310 disposed within the lower right portion of the receiver panel assembly 300, enclosed within a dashed parallelogram outline. The receiver resonant power circuitry 310 includes components arranged to form a resonant circuit tuned to the operating frequency of the transmitter panel assembly 200 to optimize power transfer efficiency between the transmitter coil 208 and the receiver coil 304.

With continued reference to FIG. 12, within the receiver resonant power circuitry 310, a plurality of receiver capacitors 312 are arranged in organized groupings, visible as circular components positioned on mounting platforms within the receiver panel assembly 300. The plurality of receiver capacitors 312 form part of the resonant circuit that is tuned to match the frequency of the high-frequency alternating current provided by the power electronics assembly 218 of the transmitter panel assembly 200. A plurality of receiver diodes 314 are also disposed within the receiver resonant power circuitry 310, positioned adjacent to the plurality of receiver capacitors 312 and configured to rectify the received alternating current for delivery to a vehicle battery system. The plurality of receiver diodes 314 convert the high-frequency power received from the transmitter coil 208 into usable direct current for charging the vehicle battery.

As further shown in FIG. 12, curved conduit and tubing elements visible throughout the receiver panel assembly 300 represent a plurality of receiver panel coolant connections 316 that establish fluid routing pathways between the plurality of receiver tubular conductors 306. The receiver panel coolant connections 316 allow fluid connection between the receiver panel assembly 300 and a coolant system of the roadway vehicle, enabling active cooling during transportation and charging operations. The receiver panel assembly 300 uses the vehicle's existing cooling loop for liquid flow through the plurality of receiver tubular conductors 306, with the cooling fluid circulating through the interior channels of the plurality of receiver tubular conductors 306 to dissipate heat generated during inductive power reception from the transmitter panel assembly 200.

In the embodiment represented in FIG. 12, the receiver panel assembly 300 is installed under the vehicle with an air gap of approximately 10 inches from the roadway surface during operation. This air gap distance positions the receiver coil 304 within effective electromagnetic coupling range of the transmitter coil 208 embedded within the roadway panels 102 as the vehicle traverses the charged pavement 116 sections. The elevated positioning of the protruded portions of the ferromagnetic element 214 within the transmitter panel assembly 200, as described previously, compensates for a portion of this air gap by lifting the magnetic material of the ferromagnetic element 212 closer to the receiver coil 304, thereby improving magnetic coupling efficiency across the approximately 10-inch separation between the roadway surface and the receiver panel assembly 300.

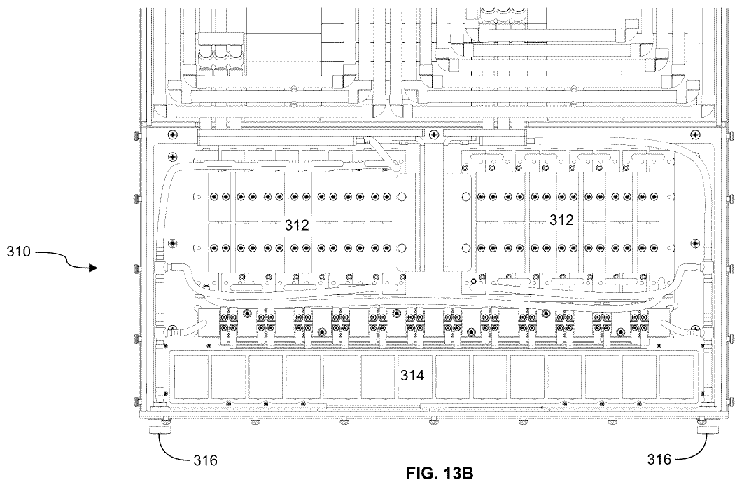

FIG. 13A illustrates a bottom plan view of the receiver panel assembly 300 for the dynamic wireless power transfer system 100, showing the internal arrangement of components within the receiver housing configured for mounting beneath a vehicle to inductively receive power from the plurality of roadway panels 102 arranged in the end-to-end configuration within the charged pavement 116 sections. In the embodiment represented in FIG. 13A, the upper section of the receiver panel assembly 300 displays the receiver coil 304 comprising the plurality of receiver tubular conductors 306 arranged in multiple parallel rows extending horizontally across the width of the receiver panel assembly 300. The plurality of receiver tubular conductors 306 are organized to form an inward to outward or outward to inward spiral electrical path configuration that differs from the transmitter coil 208 arrangement, with each receiver tubular conductor of the plurality of receiver tubular conductors 306 defining an interior channel configured to receive cooling fluid from a cooling system of the vehicle for thermal management during power transfer operations.

With continued reference to FIG. 13A, the receiver ferromagnetic material 308 is positioned between adjacent sections of the receiver coil 304 and extends along portions of the plurality of receiver tubular conductors 306 in the upper portion of the receiver panel assembly 300. The receiver ferromagnetic material 308 enhances magnetic coupling with the transmitter coil 208 embedded in the roadway panels 102 below by concentrating and directing magnetic flux during inductive power transfer.

As further shown in FIG. 13A, the lower section of the receiver panel assembly 300 contains the receiver resonant power circuitry 310, which is enclosed within a dashed rectangular outline indicated by reference numeral 310 with a lead line pointing to the bounded region. Within the receiver resonant power circuitry 310, the plurality of receiver capacitors 312 are arranged in two organized groupings positioned on either side of a central dividing structure, with each grouping containing multiple cylindrical capacitor elements arranged in parallel rows. Two instances of reference numeral 312 indicate the capacitor groupings on the left and right sides of the circuitry section. The plurality of receiver capacitors 312 form part of a resonant circuit tuned to the operating frequency of the transmitter panel assembly 200 to optimize power transfer efficiency between the transmitter coil 208 and the receiver coil 304.

With further reference to FIG. 13A, the plurality of receiver diodes 314 are disposed within the lower portion of the receiver resonant power circuitry 310, positioned below the plurality of receiver capacitors 312 and configured to rectify the received alternating current for delivery to a vehicle battery system. Reference numeral 314 indicates the diode assembly within the dashed boundary of the receiver resonant power circuitry 310. The plurality of receiver diodes 314 convert the high-frequency power received from the transmitter coil 208 into usable direct current for charging the vehicle battery during traversal of the charged pavement 116 sections.

As further shown in FIG. 13A, the receiver panel coolant connections 316 are visible at both the left and right lower corners of the receiver panel assembly 300, with two instances of reference numeral 316 indicating the fluid connection interfaces. The receiver panel coolant connections 316 allow fluid connection between the receiver panel assembly 300 and a coolant system of the roadway vehicle, enabling active cooling during transportation and charging operations by circulating cooling fluid through the interior channels of the plurality of receiver tubular conductors 306. The receiver panel assembly 300 uses the truck's existing cooling loop for liquid flow through the copper pipes of the receiver coil 304, integrating with the vehicle's thermal management infrastructure rather than requiring a dedicated cooling system for the receiver panel assembly 300.

FIG. 13B illustrates a magnified bottom plan view of the receiver panel assembly 300 for the dynamic wireless power transfer system 100, specifically showing the receiver resonant power circuitry 310 and the associated components positioned within the lower section of the receiver housing. The view provides detailed visibility of the power conversion and thermal management elements configured for mounting beneath a vehicle to process inductively received power from the plurality of roadway panels 102 embedded within the charged pavement 116 sections.

With continued reference to FIG. 13B, the receiver resonant power circuitry 310 is indicated by reference numeral 310 with a lead line and arrow pointing toward the overall circuitry assembly region. The receiver resonant power circuitry 310 encompasses the central and lower portions of the magnified view, containing the electronic components that form a resonant circuit tuned to the operating frequency of the transmitter panel assembly 200 to optimize power transfer efficiency.

In various embodiments, the command and control system is configured to synchronize phase angles of the high-frequency alternating current across the plurality of roadway panels arranged in the end-to-end configuration within the charged pavement sections. The command and control system uses EtherCAT distributed clocks to synchronize panel operating phase angles across the array of transmitter panel assemblies. EtherCAT is an industrial Ethernet-based fieldbus protocol that provides distributed clock functionality for precise time synchronization across networked devices. The command and control system applies the EtherCAT distributed clock functionality to coordinate the switching frequencies and phase relationships of the high-frequency alternating current generated by the power electronics assembly within each roadway panel of the plurality of roadway panels.

The command and control system is configured such that adjacent panels operate at nearly identical phase angles with a fixed offset there between. In various embodiments, the nearly identical phase angles between adjacent panels may be maintained within a tolerance of approximately ±5 degrees or less, with the fixed offset between adjacent panels typically ranging from approximately 1 degree to 10 degrees depending on the total number of panels in the array and the desired current distribution characteristics. For example, in an array of 100 roadway panels, the fixed offset may be approximately 3.6 degrees between adjacent panels, creating a full 360-degree phase distribution across the entire array while maintaining sufficiently small offsets between adjacent panels to ensure constructive electromagnetic field interaction. In the embodiment described herein, the fixed offset comprises a slight intentional skew between the phase angles of adjacent roadway panels so that not all units draw peak current from the power supply simultaneously. The slight intentional skew distributes the peak current draw across the plurality of roadway panels in a staggered manner, reducing the instantaneous current demand on the power supply infrastructure that delivers DC power to the roadway panels. This phase alignment with offset enables the plurality of roadway panels to operate in close proximity to one another without destructive electromagnetic interference between adjacent panels.

In various embodiments, the fixed offset between adjacent roadway panels may be selected based on the total number of roadway panels within a charged pavement section and the characteristics of the power supply infrastructure. For example, in a charged pavement section comprising approximately 100 roadway panels arranged end-to-end, the fixed offset may be configured such that the phase angles are distributed across the array in a manner that prevents any substantial subset of the roadway panels from reaching peak current draw at the same instant. The cumulative effect of the fixed offsets across the entire array creates a diversity of phase angles relative to the common power source provided by the power supply infrastructure, while any two adjacent roadway panels maintain nearly identical phase relationships that enable constructive electromagnetic field interaction.

The phase alignment with offset configuration addresses two distinct technical considerations for dynamic wireless power transfer systems deployed in long continuous sequences. First, the nearly identical phase angles between adjacent roadway panels ensure that the electromagnetic fields generated by the transmitter coils of adjacent panels combine constructively rather than destructively. When electromagnetic fields from adjacent transmitter coils are substantially out of phase, the fields may cancel or interfere in the transition region between panels, creating dead zones where power transfer efficiency decreases. By maintaining nearly identical phase angles between adjacent panels, the command and control system enables the electromagnetic fields to reinforce one another in the transition regions, providing continuous power transfer as a vehicle traverses from one roadway panel to the next.

Second, the fixed offset between phase angles prevents simultaneous peak current draw that would otherwise create large instantaneous current demands on the power supply infrastructure. In high-power wireless charging applications for heavy-duty trucks, each roadway panel may draw substantial current during the peak portions of the high-frequency alternating current waveform. If all roadway panels within a charged pavement section were to reach peak current draw simultaneously, the aggregate instantaneous current demand could exceed the capacity of the power supply infrastructure or require substantially oversized power distribution equipment. The fixed offset staggers the peak current draw across the plurality of roadway panels such that while some panels are at peak current, others are at intermediate or minimum current levels, thereby reducing the peak-to-average ratio of the aggregate current demand on the power supply infrastructure. In multi-vehicle charging load applications, this also creates an offset to the shared power bus, which decreases the total power draw on the entire bus the power supply needs to provide.

The power penalty associated with the fixed offset between adjacent panels is dependent on the cosine of the phase shift, resulting in minimal power transfer reduction for small angular offsets. For example, a phase offset of approximately 4 degrees between adjacent panels delivers approximately 99.7% of the power that would be transferred at zero phase offset, representing a negligible reduction in charging efficiency. This small per-panel offset accumulates across the array such that a full range of 360 degrees of phase diversity is produced over any section of approximately 90 panels. The resulting phase diversity across the array provides substantial benefits in practical implementations involving multiple receiver vehicles traversing the charged pavement section simultaneously. When multiple vehicles are positioned at various locations along a one-mile roadway section, each vehicle encounters transmitter panels operating at different phase angles relative to the common power source, distributing the aggregate power demand across the full phase cycle rather than concentrating demand at particular phase angles. This diversity characteristic reduces peak loading on the power supply infrastructure while maintaining high power transfer efficiency to each individual vehicle.

The command and control system implements the phase alignment with offset using the EtherCAT distributed clock functionality to maintain precise timing relationships across the array of roadway panels. Each roadway panel receives timing information from the command and control system that specifies the phase angle at which the power electronics assembly should generate the high-frequency alternating current supplied to the transmitter coil. The command and control system calculates the appropriate phase angle for each roadway panel based on the panel's position within the array and the desired fixed offset between adjacent panels, then communicates the timing parameters to each panel through the EtherCAT network. The distributed clock functionality of EtherCAT provides sub-microsecond synchronization accuracy across the networked roadway panels, enabling precise control of the phase relationships even at the high operating frequencies used for wireless power transfer.

The synchronization of phase angles across the plurality of roadway panels enables tight panel spacing that eliminates large separations between adjacent panels that would otherwise be used in prior dynamic wireless power transfer implementations. In conventional dynamic wireless charging systems, transmitter coils are spaced apart to prevent electromagnetic interference between adjacent coils operating at high frequencies. The command and control system described herein coordinates the phase relationships of the high-frequency alternating current across the array such that the electromagnetic fields generated by adjacent roadway panels do not interfere destructively. The nearly identical phase angles between adjacent panels cause the electromagnetic fields to combine constructively rather than destructively, while the fixed offset between phase angles prevents simultaneous peak current draw that would otherwise overload the power supply infrastructure.

The phase synchronization provided by the command and control system enables the plurality of roadway panels to be placed adjacent to one another in the end-to-end configuration, with the respective electromagnetic fields of adjacent panels forming a larger, synchronized magnetic field. This synchronized magnetic field minimizes dead zones between panels and provides continuous and efficient wireless power transfer as vehicles traverse the charged pavement sections. The command and control system monitors and adjusts the phase angles of each roadway panel in real-time to maintain the nearly identical phase relationship with the fixed offset across the entire array of roadway panels, accommodating variations in operating conditions and ensuring consistent power transfer characteristics along the length of the charged pavement sections.

The dynamic wireless power transfer system 100 is configured to operate in multiple operational modes using the same transmitter panel assemblies 200 and receiver panel assemblies 300. The operational modes include a dynamic mode, a semi-static mode, and a static mode, with the mode selection determined by the command and control system based on vehicle speed, vehicle position, operational parameters, or user selection.

In the dynamic mode, the command and control system activates individual transmitter panels sequentially as a vehicle traverses the charged pavement 116 section, with each panel energized for a brief activation window corresponding to the time required for the vehicle to pass over the panel. The phase synchronization with fixed offset coordinates the electromagnetic fields of adjacent panels to provide continuous power transfer during vehicle motion. Thermal management in the dynamic mode relies on adiabatic cooling through the thermal mass of the transmitter panel components.

In the semi-static mode, the command and control system activates one or more transmitter panels for extended periods while a vehicle is temporarily stationary or moving at reduced speed. Semi-static charging occurs during vehicle queuing, loading operations, brief stops, or controlled low-speed movement. The command and control system adjusts power levels and activation timing based on the detected vehicle speed and anticipated dwell time. Thermal management in the semi-static mode utilizes active cooling fluid circulation when activation periods exceed the thermal absorption capacity of the transmitter panel components.

In the static mode, the command and control system activates one or more transmitter panels for sustained charging while a vehicle remains stationary over the transmitter infrastructure. Static charging occurs at designated parking locations, depot facilities, or other locations where vehicles remain stationary for extended periods. The command and control system regulates power delivery based on vehicle battery state and charging requirements communicated from the vehicle. Thermal management in the static mode utilizes continuous active cooling fluid circulation to maintain thermal equilibrium during sustained high-power operation.

The transmitter panel assemblies 200 and receiver panel assemblies 300 are configured identically across all operational modes, with the mode-specific behavior determined by software configuration of the command and control system. This unified hardware approach simplifies manufacturing, installation, and maintenance while providing operational flexibility across different charging scenarios and vehicle types.

As used herein, the phrase “one or more of,” when used with a list of items, means that different combinations of one or more of the listed items may be used, and only one of each item in the list may be needed. In other words, “one or more of” means any combination of items and number of items may be used from the list, but not all of the items in the list are required. The item may be a particular object, a thing, or a category.

For example, “one or more of item A, item B, or item C” may include item A, item A and item B, item B, item A and item B and item C, or item B and item C. In some cases, “one or more of item A, item B, or item C” may mean, for example, without limitation, two of item A, one of item B, and ten of item C; four of item B and seven of item C; or other suitable combinations.

As used herein, the phrase “at least one of,” when used with a list of items, means that different combinations of one or more of the listed items may be used, and only one of each item in the list may be needed. For example, “at least one of item A, item B, and item C” may include item A, item A and item B, item B, item A and item B and item C, item B and item C, or item A and item C. In some cases, “at least one of item A, item B, and item C” may mean, for example, without limitation, two of item A, one of item B, and ten of item C; four of item B and seven of item C; or other suitable combinations.

As used herein, the terms “coupled,” “connected,” and similar terms refer to two or more elements that are joined, linked, fastened, attached, or otherwise associated with each other. Such association may be mechanical, electrical, fluid, thermal, or a combination thereof. The elements may be associated directly or indirectly with each other.

As used herein, the term “configured to” describes a component, element, or assembly that is constructed, arranged, or programmed to perform a specified function. The term does not imply that the component, element, or assembly is the only way to perform the specified function, nor does the term exclude other components, elements, or assemblies that may also perform the specified function.

The foregoing description has been presented for purposes of illustration and description. The description is not intended to be exhaustive or to limit the disclosure to the precise form disclosed. Various modifications, variations, and combinations of the described embodiments are possible in light of the above teachings. The embodiments described herein were chosen to explain the principles of the disclosure and practical applications, and to enable others of ordinary skill in the art to understand the disclosure for various embodiments with various modifications as are suited to the particular use contemplated.

The apparatus and methods disclosed herein may be implemented in various forms and configurations beyond those specifically illustrated and described. The dimensions, materials, arrangements, and operational parameters described herein are exemplary and may be varied to suit particular applications and operating environments. Alternative embodiments may include different combinations of the features described, different arrangements of components, and different operational sequences.

Each disclosed feature or embodiment may be combined with any of the other disclosed features or embodiments.

A number of implementations have been described. Nevertheless, it will be understood that various modifications may be made without departing from the spirit and scope of the disclosure. Accordingly, other implementations are within the scope of the following claims.

1. A precast roadway inductive charging panel for (or semi-static, or static) wireless power transfer to a vehicle, the panel comprising:
a transmitter coil comprising a plurality of tubular conductors, each one of the plurality of tubular conductors defining an interior channel configured to receive a cooling fluid therethrough;
one or more bus bar assemblies electrically coupled to the plurality of tubular conductors, each bus bar assembly comprising a planar conductive plate positioned at an end of at least two tubular conductors of the plurality of tubular conductors to form a electrical path through the transmitter coil;
a power electronics assembly electrically coupled to the transmitter coil and configured to provide high-frequency alternating current to the transmitter coil; and
a ferromagnetic element comprising one or more protruded portions arranged between at least two adjacent ones of the plurality of tubular conductors.

2. The panel of claim 1, wherein:
the plurality of tubular conductors comprises a first plurality of tubular conductors and a second plurality of tubular conductors;
the one or more protruded portions of the ferromagnetic element are arranged between the first plurality of tubular conductors and the second plurality of tubular conductors;
adjacent ones of the first plurality of tubular conductors and of the second plurality of tubular conductors do not include the one or more protruded portions therebetween.

3. The panel of claim 2, wherein:
a first bus bar assembly of the at least two bus bar assemblies is arranged at a first end of both the first plurality and second plurality of tubular conductors;
the planar conductive plate comprising a plurality of conductive plates forming a staggered interconnect arrangement, each conductive plate electrically coupling a different overlapping subset of conductors of the first plurality of tubular conductors with a different overlapping subset of the second plurality of conductors.

4. The panel of claim 2, further comprising:
for each of the plurality of tubular conductors, a cooling fluid connection between a single one of the first plurality of tubular conductors and a single one of the second plurality of tubular conductors.

5. The panel of claim 1, wherein the one or more protruded portions elevate the ferromagnetic element above a plane defined by bottom surfaces of the plurality of tubular conductors.

6. The panel of claim 2, wherein the one or more protruded portions elevate the ferromagnetic element above a plane defined by top surfaces of the plurality of tubular conductors.

7. The panel of claim 1, wherein the plurality of tubular conductors comprise copper or aluminum.

8. The panel of claim 1, further comprising a concrete body encasing the transmitter coil, the at least two bus bar assemblies, the power electronics assembly, and the ferromagnetic element.

9. The panel of claim 4, further comprising:
at least one support plate extending across at least a portion of the transmitter coil;
a reinforcement bar; and
wherein the at least one support plate comprises a first indentation configured to contact each of the plurality of tubular conductors across which the at least one support plate extends and a second indentation configured to contact the reinforcement bar.

10. The panel of claim 1, where the at least two adjacent ones of the plurality of tubular conductors astride the one or more protruded portions comprise a diameter smaller than the others of the plurality of tubular conductors.

11. The panel of claim 1, further comprising a non-rectangular trapezoidal planform.

12. The panel of claim 7, further comprising an oblique parallelogram planform.

13. The panel of claim 1, wherein:
the power electronics assembly is disposed within a magnetic field generated by the transmitter coil; and
wherein the panel further comprises a shielding layer disposed between the transmitter coil and the power electronics assembly.

14. The panel of claim 13, wherein the shielding layer comprises aluminum.

15. A dynamic wireless power transfer system comprising:
a plurality of precast roadway inductive charging panels arranged in an end-to-end configuration to form a continuous driving surface, each panel of the plurality of panels comprising:
a transmitter coil comprising a plurality of tubular conductors, each of the plurality of tubular conductors defining an interior channel configured to receive a cooling fluid therethrough;
at least two bus bar assemblies electrically coupled to the plurality of tubular conductors, each bus bar assembly comprising a planar conductive plate positioned at a respective end of at least two of the plurality of tubular conductors to form a continuous electrical path through the transmitter coil;
a power electronics assembly electrically coupled to the transmitter coil and configured to provide high-frequency alternating current to the transmitter coil;
a ferromagnetic element comprising one or more protruded portions arranged between at least two adjacent ones of the plurality of tubular conductors;
a vehicle-mounted receiver assembly configured to be positioned beneath a vehicle and to inductively receive power from the plurality of precast roadway inductive charging panels, the receiver assembly comprising a receiver coil selectively electromagnetically coupleable to the transmitter coil of at least one of the plurality of panels;
a power supply infrastructure electrically coupled to the plurality of panels and configured to convert power from a power grid into DC power distributed to each of the plurality of panels; and
a command and control system communicatively coupled to the plurality of panels and configured to regulate power distribution to the plurality of panels.

16. The system of claim 15, wherein a plurality of intermediate ones of the plurality of panels comprise a non-rectangular trapezoidal planform.

17. The system of claim 15, wherein the plurality of panels comprise a plurality of separated panel segments, each panel segment separated by a road segment devoid of any panel.

18. The system of claim 17, wherein at least one of the plurality of separated panel segments extends over half a mile.

19. The system of claim 15, wherein the command and control system is configured to synchronize phase angles of the high-frequency alternating current across the plurality of panels such that adjacent panels operate at nearly identical phase angles with a fixed offset therebetween.

20. The system of claim 15, wherein:
the receiver coil comprises a plurality of receiver tubular conductors, each receiver tubular conductor defining an interior channel configured to receive a cooling fluid from a cooling system of the vehicle; and
the receiver assembly further comprises a ferromagnetic material disposed between at least two adjacent ones of the plurality of receiver tubular conductors.
